(19) United States
(12) Patent Application Publication
(10) Pub. No.: US 2015/0082345 A1
(43) Pub. Date: Mar. 19, 2015

(54) SYSTEM FOR GENERATING ENHANCED ADVERTIZEMENTS AND METHODS FOR USE THEREWITH

(71) Applicant: AVVASI INC., WATERLOO (CA)

(72) Inventors: Michael Archer, Cambridge (CA); Michael Gallant, Kitchener (CA)

(73) Assignee: AVVASI INC., WATERLOO (CA)

(21) Appl. No.: 14/328,279

(22) Filed: Jul. 10, 2014

Related U.S. Application Data
(63) Continuation-in-part of application No. 13/631,366, filed on Sep. 28, 2012.
(60) Provisional application No. 61/846,605, filed on Jul. 15, 2013.
(60) Provisional application No. 61/541,046, filed on Sep. 29, 2011.

(51) Int. Cl. H04N 21/2668; H04N 21/258; H04N 21/81

(52) U.S. Cl. CPC H04N 21/2668; H04N 21/812; H04N 21/25891
USPC 725/34

(57) ABSTRACT

A system includes a video services gateway that detects an ad request, sent via a network, from at least one of the plurality of client devices to a real-time ad exchange system and generates an indication of the ad request. A service provider advertising engine receives the indication of the ad request from the video services gateway, generates a bid to the real-time ad exchange system to fulfill an ad opportunity corresponding to the ad request, retrieves subscriber data associated with the at least one client device from a subscriber database, when the bid is successful, annotates the ad opportunity with the subscriber data and submits the annotated ad opportunity to the real-time ad exchange system for rebidding.

### CROSS REFERENCE TO RELATED APPLICATIONS

The present U.S. Utility patent application claims priority pursuant to 35 U.S.C. §119(e) to U.S. Provisional Application No. 61/846,605 entitled ‘Mobile Video Advertising Ecosystem Enhancement’, filed Jul. 15, 2013, which is hereby incorporated herein by reference in its entirety and made part of the present U.S. Utility patent application for all purposes.

The present U.S. Utility patent application also claims priority pursuant to 35 U.S.C. §120 as a continuation-in-part of U.S. Utility application Ser. No. 13/631,366, entitled “Systems And Methods For Media Service Delivery”, filed Sep. 28, 2012, pending, which claims priority pursuant to 35 U.S.C. §119(e) to U.S. Provisional Application No. 61/541,046, entitled “Method and System for IP Video Service Delivery”, filed Sep. 29, 2011, both of which are hereby incorporated herein by reference in their entirety and made part of the present U.S. Utility patent application for all purposes.

### TECHNICAL FIELD OF THE INVENTION

The present invention relates to interactive advertising and particularly in conjunction with video distribution in mobile networks and other networks.

### DESCRIPTION OF RELATED ART

Streaming media sent over various computer networks is increasingly popular. Maintaining such streaming is becoming a problem for the organizations providing and maintaining such networks. Streaming media has become an integral element of the ‘Internet experience’ through the significant availability of content from sites like YouTube, Netflix and many others. Solutions exist that allow advertisements to be included in streaming media. In one example the consumer browses to the content provider's site. When the consumer chooses a video to watch, an embedded video player is downloaded to the consumer's device which contains an embedded link to the selected video as well as break points within the content on when and where the player should request video ads from to be played. These can be pre-roll, mid-roll or post roll and potentially include interactivity features etc. The ad servers are supplied by either the content provider managing them and building and managing ad inventory or can be managed by a third party which is building a library of available ad content or potentially even the advertiser themselves. These systems strive to plan and manage the ad campaign and set the target demographic desired for the particular content/ad. The business model is usually direct between the content provider and the advertiser or third party aggregator of advertisers.

In a more sophisticated model a real-time video ad exchange may optionally be involved in the flow, selling the advertising opportunity in an online auction. In this model, the content provider has a business relationship with a real-time video ad exchange that receives the ad request and conducts an online real-time auction between advertisers or third parties to sell the video advertising opportunity. The advertisers compete for the advertising opportunity and the value is determined by how targeted the opportunity is and how much each advertiser is willing to pay for a certain level of targeting. The bidding process is completely automated by intelligent systems that use sophisticated algorithms to match the opportunity to the advertiser to maximize value for both the advertiser and the consumer. When the auction has closed, the winning bidder then has the right to serve the video ad from their video ad servers to the player.

The current advertising ecosystem has traditionally been a fragmented market of proprietary solutions with small consumer bases constraining adoption and driving cost in the ecosystem. The Interactive Advertising Bureau (IAB) has set about standardizing the ecosystem in order to bring uniformity and ubiquitous standards to the market in order to lower cost, increase market size, penetration and adoption of advertising solutions on the mobile platform. The IAB has defined a suite of application interfaces and best practices for the industry and provided a test framework to help determine inter-operability.

The limitations and disadvantages of conventional and traditional approaches will become apparent to one of ordinary skill in the art through comparison of such systems with the present invention.

### BRIEF DESCRIPTION OF THE SEVERAL VIEWS OF THE DRAWINGS

FIG. 1 is a schematic block diagram illustrating a system in accordance with an embodiment of the present invention;

FIG. 2A is a schematic block diagram illustrating a system in accordance with an embodiment of the present invention;

FIG. 2B is a diagram illustrating a method in accordance with an embodiment of the present invention;

FIG. 3 is a diagram illustrating a method in accordance with an embodiment of the present invention;

FIG. 4 is a diagram illustrating a method in accordance with an embodiment of the present invention;

FIG. 5 is a schematic block diagram illustrating a system in accordance with an embodiment of the present invention;

FIG. 6 is a schematic block diagram of a system including a streaming media optimizer in accordance with an embodiment of the present invention;

FIG. 7 is a schematic block diagram of a container processor in accordance with an embodiment of the present invention;

FIG. 8 is a diagram illustrating a method in accordance with an embodiment of the present invention;

FIG. 9 is a schematic block diagram of a system including a service provider in accordance with an embodiment of the present invention;

FIG. 10 is a diagram illustrating communications in accordance with an embodiment of the present invention;

FIG. 11 is a diagram illustrating communications in accordance with an embodiment of the present invention;

FIG. 12 is a schematic block diagram of a system including a service provider in accordance with an embodiment of the present invention;

FIG. 13 is a diagram illustrating communications in accordance with an embodiment of the present invention; and

FIG. 14 is a diagram illustrating a method in accordance with an embodiment of the present invention.

### DETAILED DESCRIPTION OF THE INVENTION INCLUDING THE PRESENTLY PREFERRED EMBODIMENTS

The described methods and systems generally allow the quality of a media session to be adjusted or controlled in order to correspond to a target quality. In some embodiments, the quality of the media session can be controlled by encoding the media session. Encoding is the operation of converting a media signal, such as, an audio and/or a video signal from a source format, typically an uncompressed format, to a compressed format. A format is defined by characteristics such as bit rate, sampling rate (frame rate and spatial resolution), coding syntax, etc.

In some other embodiments, the quality of the media session can be controlled by transcoding the media session. Transcoding is the operation of converting a media signal, such as, an audio signal and/or a video signal, from one format into another. Transcoding may be applied, for example, in order to change the encoding format (e.g., such as a change in compression format from H.264 to VP8), or for bit rate reduction to adapt media content to an allocated bandwidth.

In some further embodiments, the quality of a media session that is delivered using an adaptive streaming protocol can be controlled using methods applicable specifically to such protocols. Examples of adaptive streaming control include request-response modification, manifest editing, conventional shaping or policing, and may include transcoding. In adaptive streaming control approaches, request-response modification may cause client segment requests for high definition content to be replaced with similar requests for standard definition content. Manifest editing may include modifying the media stream manifest files that are sent in response to a client request to modify or reduce the available operating points in order to control the operating points that are available to the client. Accordingly, the client may make further requests based on the altered manifest. Conventional shaping or policing may be applied to adaptive streaming to limit the media session bandwidth, thereby forcing the client to remain at or below a certain operating point.

Media content is typically encoded or transcoded by selecting a target bit rate. Conventionally, quality is assessed based on factors such as format, encoding options, resolutions and bit rates. The large variety of options, coupled with the wide range of devices on which content may be viewed, has conventionally resulted in widely varying quality across sessions and across viewers. Adaptation based purely on bit rate reduction, does little to improve this situation. It is generally beneficial if the adaptation is based on one or more targets for one or more quality metrics that can normalize across these options.

The described methods and systems, however, may control quality of the media session by selecting a target quality level in a more comprehensive quality metric, for example based on quality of experience. In some cases, the quality metric may be in the form of a numerical score. In some other cases, the quality metric may be in some other form, such as, for example, a letter score, a descriptive (e.g. high′, ‘medium’, low) etc. The quality metric may be expressed as a range of scores or an absolute score or as a relative score.

A Quality of Experience (QoE) measurement on a Mean Opinion Score (MOS) scale is one example of a perceptual quality metric, which reflects a viewer's opinion of the quality of the media session. For ease of understanding, the terms perceptual quality metric and QoE metric may be used interchangeably herein. However, a person skilled in the art will understand that other quality metrics may also be used.

A QoE score or measurement can be considered as a subjective way of describing how well a user is satisfied with a media presentation. Generally, a QoE measurement may reflect a user's actual or anticipated viewing quality of the media session. Such a calculation may be based on events that impact viewing experience, such as network induced re-buffering events wherein the playback stalls. In some cases, a model of human dissatisfaction may be used to provide QoE measurement. For example, a user model may map a set of video buffer state events to a level of subjective satisfaction for a media session. In some other cases, QoE may reflect an objective score where an objective session model may map a set of hypothetical video buffer state events to an objective score for a media session.

A QoE score may in some cases consist of two separate scores, for example a Presentation Quality Score (PQS) and a Delivery Quality Score (DQS) or a combination thereof. PQS generally measures the quality level of a media session, taking into account the impact of media encoding parameters and optionally device-specific parameters on the user experience, while ignoring the impact of delivery. For PQS calculation, relevant audio, video and device key performance indicators (KPIs) may be considered from each media session. These parameters may be incorporated into a no-reference bitstream model of satisfaction with the quality level of the media session.

KPIs that can be used to compute the PQS may include codec type, resolution, bits per pixel, frame rate, device type, display size, and dots per inch. Additional KPIs may include coding parameters parsed from the bitstream, such as macroblock mode, macroblock quantization parameter, coded macroblock size in bits, intra prediction mode, motion compensation mode, motion vector magnitude, transform coefficient size, transform coefficient distribution and coded frame size etc. The PQS may also be based, at least in part, on content complexity and content type (e.g., movies, news, sports, music videos etc.). The PQS can be computed for the entirety of a media session, or computed periodically throughout a media session.

DQS measures the success of the network in streaming delivery, reflecting the impact of network delivery on QoE while ignoring the source quality. DQS calculation may be based on a set of factors, such as, the number, frequency and duration of re-buffering events, the delay before playback begins at the start of the session or following a seek operation, buffer fullness measures (such as average, minimum and maximum values over various intervals), and durations of video downloaded/streamed and played/watched. In cases where adaptive bit rate streaming is used, additional factors may include a number of stream switch events, a location in the media stream, duration of the stream switch event, and a change in operating point for the stream switch event.

Simply reporting on the overall number of stalls or stall frequency per playback minute may be insufficient to provide a reliable representation of QoE. To arrive at an accurate DQS score, the model may be tested with, and correlated to, numerous playback scenarios, using a representative sample of viewers.

Further details relating to the computation of such metrics may be found, for example, in U.S. patent application Ser. Nos. 13/283,898, 13/480,964 and 13/053,650, the contents of which are incorporated herein by reference for any and all purposes.

The described methods and systems may enable service providers to provide their subscribers with assurance that content accessed by the subscribers conform to one or more agreed upon quality levels. This may enable creation of pricing models based on the quality of the subscriber experiences.

The described methods and systems may also enable service providers to provide multimedia content providers and aggregators with assurance that the content is delivered at one or more agreed upon quality levels. This may also enable creation of pricing models based on the assured level of content quality.

The described methods and system may further enable service providers to deliver the same or similar multimedia quality across one or more disparate sessions in a given network location.

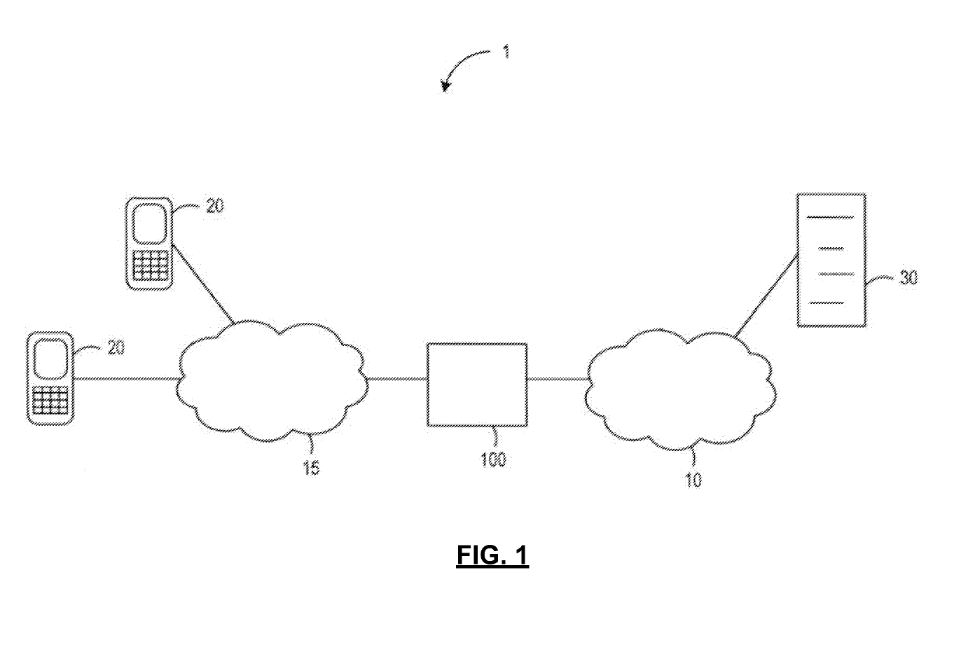

FIG. 1 is a schematic block diagram illustrating a system in accordance with an embodiment of the present invention. System 1 generally includes a data network 10, such as the Internet, which connects a media server 30 and a media session control system 100.

Media session control system 100 is further connected to one or more access networks 15 for client devices 20, which may be mobile computing devices such as smartphones, for example. Accordingly, access networks 15 may include radio access networks (RANs) and backhaul networks, in the case of a wireless data network. In particular, the networks 15 can include a wireless network such as a cellular network that operates in conjunction with a wireless data protocol such as high-speed downlink packet access (HSDPA), high-speed uplink packet access (HSUPA and/or variations thereof) 3GPP (third generation partnership project), LTE (long term evolution), UMTS (Universal Mobile Telecommunications System) and/or other cellular data protocol, a wireless local area network protocol such as IEEE 802.11, IEEE 802.16 (WiMAX), Bluetooth, ZigBee, or any other type of radio frequency based network protocol.

Although the exemplary embodiments are shown primarily in the context of mobile data networks, it will be appreciated that the described systems and methods are also applicable to other network configurations. For example, the described systems and methods could be applied to data networks using satellite, digital subscriber line (DSL) or data over cable service interface specification (DOCSIS) technology in lieu of, or in addition to a mobile data network. In particular, the networks 15 can include a wireline network such as a cable network, hybrid fiber coax (HFC) network, a fiber optic network, a telephone network, a powerline based data network, an intranet, the Internet, and/or other network.

Media session control system 100 is generally configured to forward data packets associated with the data sessions of each client device 20 to and from network 10, preferably with minimal latency. In some cases, as described herein further, media session control system 100 may modify the data sessions, particularly in the case of media sessions (e.g., streaming video or audio).

Client devices 20 generally communicate with one or more servers 30 accessible via network 10. It will be appreciated that servers 30 may not be directly connected to network 10, but may be connected via intermediate networks or service providers. In some cases, servers 30 may be edge nodes of a content delivery network (CDN). As discussed above, the client devices can be mobile devices such as smartphones, internet tablets, personal computers or other mobile devices that are coupleable to network 15 and are configurable to playback streaming media via a media player. In other embodiments, the client devices 20 can be other media clients such as an IP television, set-top box, personal media player, Digital Video Disc (DVD) player with streaming support, Blu-Ray player with streaming support or other media client that is coupleable to network 15 to support the playback of streaming media.

It will be appreciated that network system 1 shows only a subset of a larger network, and that data networks will generally have a plurality of networks, such as network 10 and access networks 15.

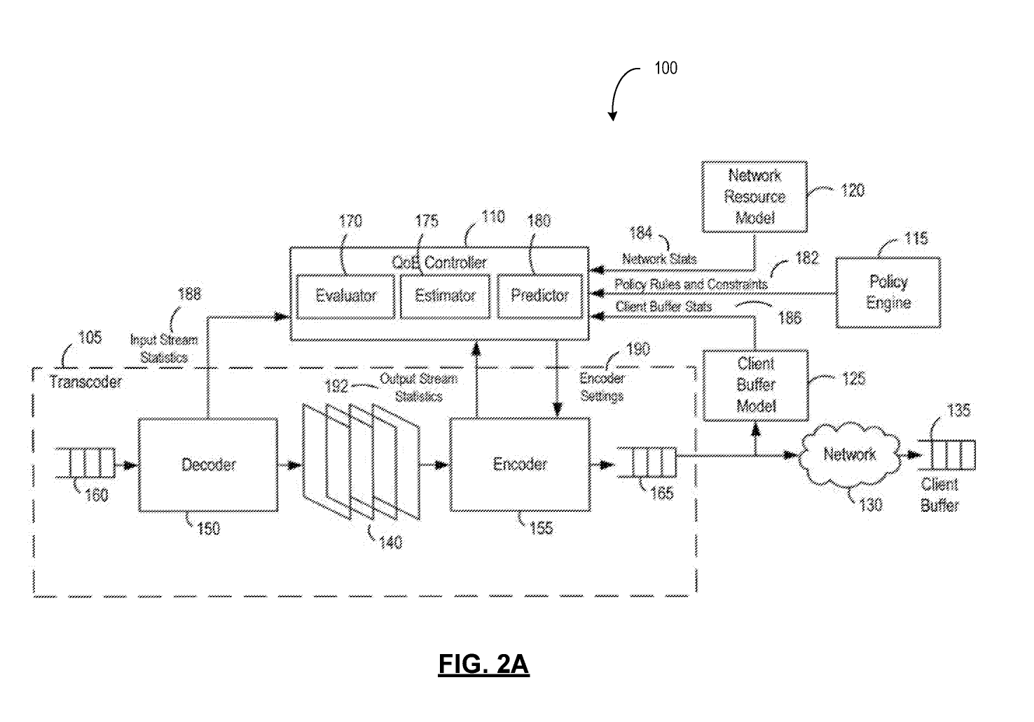

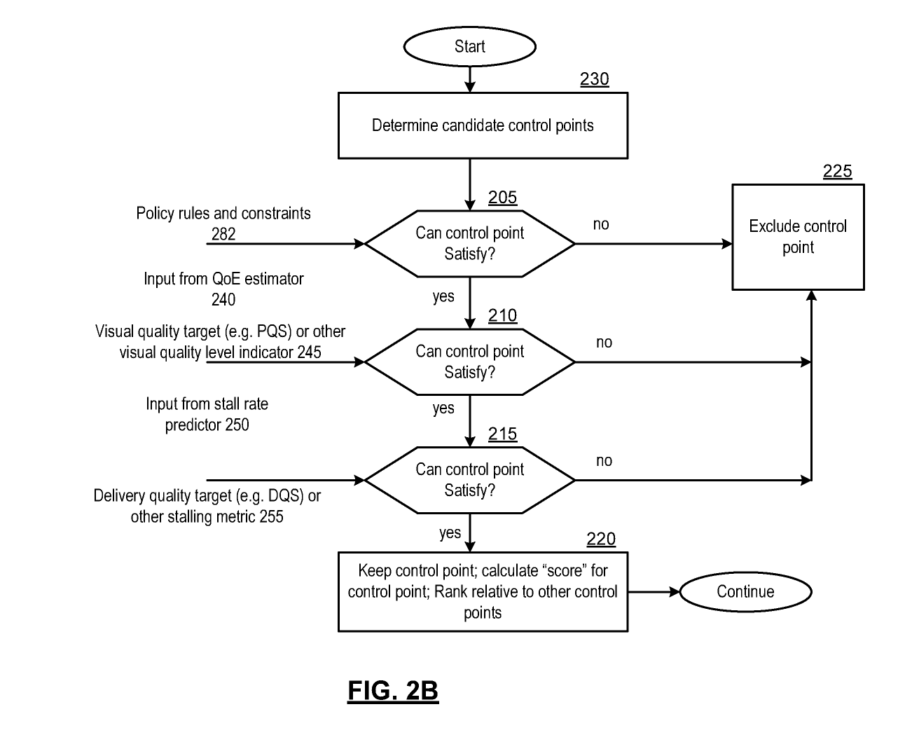

FIG. 2A is a schematic block diagram illustrating a system in accordance with an embodiment of the present invention. Control system 100 generally has a transcoder 105, a QoE controller 110, a policy engine 115, a network resource model module 120, a client buffer model module 125. Control system 100 is generally in communication with a client device which is receiving data into its client buffer 135, via a network 130.

Policy Engine

Policy Engine 115 may maintain a set of policies, and other configuration settings in order to perform active control and management of media sessions. In various cases, the policy engine 115 is configurable by the network operator. The configuration of the policy engine 115 may be dynamically changed by the network operator. For example, in some embodiments, policy engine 115 may be implemented as part of a Policy Charging and Rules Function (PCRF) server.

Policy engine 115 provides policy rules and constraints 182 to the QoE controller 110 to be used for a media session under management by system 100. Policy rules and constraints 182 may include one or more of a quality metric and an associated target quality level, a policy action, scope or constraints associated with the policy action, preferences for the media session characteristics, etc. Policy rules and constraints 182 can be based on the subscriber or client device, service, content type, time-of-day or may be based on other factors.

The target quality level may be an absolute quality level, such as, a numerical value on a MOS scale. The target quality level may alternatively be a QoE range, i.e., a range of values with a minimum level and a maximum level.

Policy engine 115 may specify a wide variety of quality metrics and associated target quality levels. In some cases, the quality metric may be based on an acceptable encoding and display quality, or a presentation QoE score (PQS). In some other cases, the quality metric may be based on an acceptable network transmission and stalling impact on quality, or a delivery QoE score (DQS). In some further cases, the quality metric may be based on the combination of the presentation and the delivery QoE scores, or a combined QoE score (CQS).

Policy engine 115 may determine policy actions for a media session, which may include a plurality of actions. For example, a policy action may include a transcoding action, an adaptive streaming action which may also include a transcoding action, or some combination thereof.

Policy engine 115 may specify the scope or constraints associated with policy actions. For example, policy engine 115 may specify constraints associated with a transcoding action. Such constraints may include specifying the scope of one or more individual or aggregate media session characteristics. Examples of media session characteristics may include bit rate, resolution, frame rate, etc. Policy engine 115 may specify one or more of a target value, a minimum value and a maximum value for the media session characteristics.

Policy engine 115 may also specify the preference for the media session characteristic as an absolute value, relative value, a range of values and/or a value with qualifiers. For example, policy engine 115 may specify a preference with qualifiers for the media session characteristic by providing that the minimum frame rate value of 10 is a ‘strong’ preference. In other examples, policy engine 115 may specify that the minimum frame rate value is a ‘medium’ or a ‘weak’ preference.

Network Resource Model Module

Network Resource Model (NRM) module 120 may implement a hierarchical subscriber and network model and a load detection system that receives location and bandwidth information from the rest of the system (e.g., networks 10 and 15 of system 1) or from external network nodes, such as radio access network (RAN) probes, to generate and update a real-time model of the state of a mobile data network, in particular congested domains, e.g. sectors.

NRM module 120 may update and maintain an NRM based on data from at least one network domain, where the data may be collected by a network event collector (not shown) using one or more node feeds or reference points. The NRM module may implement a location-level congestion detection algorithm using measurement data, including location, RTT, throughput, packet loss rates, windows sizes, and the like. NRM module 120 may receive updates to map subscribers and associated traffic and media sessions to locations.

NRM module 120 provides network statistics 184 to the QoE controller 110. Network statistics 184 may include one or more of the following statistics, such as, for example, current bit rate/throughput for session, current sessions for location, predicted bit rate/throughput for session, and predicted sessions for location, etc.

Client Buffer Model Module

Client buffer model module 125 may use network feedback and video packet timing information specific to a particular ongoing media session to estimate the amount of data in a client device's playback buffer at any point in time in the media session.

Client buffer model module 125 generally uses the estimates regarding amount of data in a client device's playback buffer, such as client buffer 135, to model location, duration and frequency of stall events. In some cases, the client buffer model module 125 may directly provide raw data to the QoE controller 110 so that it may select a setting that minimizes the likelihood of stalling, with the goal of achieving better streaming media performance and improved QoE metric, where the QoE metric can include presentation quality, delivery quality or other metrics.

Client buffer model module 125 generally provides client buffer statistics 186 to the QoE controller 110. Client buffer statistics 186 may include one or more of statistics such as current buffer fullness, buffer fill rate, a playback indicator/time stamp at the client buffer, and an input indicator/timestamp at the client buffer, etc.

Transcoder

Transcoder 105 generally includes a decoder 150 and an encoder 155. Decoder 150 has an associated decoder input buffer 160 and encoder 155 has an associated encoder output buffer 165, each of which may contain bitstream data.

Decoder 150 may process the input video stream at an application and/or a container layer level and, as such, may include a demuxer. Decoder 150 provides input stream statistics 188 to the QoE controller 110. Input stream statistics 188 may include one or more statistics or information about the input stream. The input stream may be a video stream, an audio stream, or a combination of the video and the audio streams.

Input stream statistics 188 provided to the QoE controller 110 may include one or more of streaming protocol, container type, device type, codec, quantization parameter values, frame rate, resolution, scene complexity estimate, picture complexity estimate, Group of Pictures (GOP) structure, picture type, bits per GOP, bits per picture, etc.

Encoder 155 may be a conventional video or audio encoder and, in some cases, may include a muxer or remuxer. Encoder 155 typically receives decoded pictures 140 and encodes them according to one or more encoding parameters. Encoder 155 typically handles picture type selection, bit allocation within the picture to achieve the overall quantization level selected by control point evaluation, etc. Encoder 155 may include a look-ahead buffer to enable such decision making. Encoder may also include a scaler/resizer for resolution and frame rate reduction. Encoder 155 may make decisions based on encoder settings 190 received from the QoE controller 110.

Encoder 155 provides output stream statistics 192 to the QoE controller 110. Output stream statistics 192 may include one or more of the following statistics or information about the transcoded/output stream, such as, for example, container type, streaming protocol, codec, quantization parameter values, scene complexity estimate, picture complexity estimate, GOP structure, picture type, frame rate, resolution, bits/GOP, bits/picture, etc.

QoE Controller

QoE Controller 110 is generally configured to select one control point from a set of control points during a control point evaluation process. A control point is set of attributes that define a particular operating point for a media session, which may be used to guide an encoder, such as encoder 155, and/or a transcoder, such as transcoder 105. The set of attributes that make up a control point may be transcoding parameters, such as, for example, resolution, frame rate, quantization level etc.

In some cases, the QoE controller 110 generates various control points. In some other cases, QoE controller 110 receives various control points via network 130. The QoE controller 110 may receive the control points, or constraints for control points, from the policy engine 115 or some external processor.

In some cases, the media streams that represent a particular control point may already exist on a server (e.g. for adaptive streams) and these control points may be considered as part of the control point evaluation process. Selecting one of the control points for which a corresponding media stream already exists may eliminate the need for transcoding to achieve the control point. In such cases, other mechanisms such as shaping, policing, and request modification may be applied to deliver the media session at the selected control point.

Control point evaluation may occur at media session initiation as well as dynamically throughout the course of the session. In some cases, some of the parameters associated with a control point may be immutable once selected (e.g., resolution in some formats).

QoE controller 110 provides various encoder settings 190 to the transcoder 105 (or encoder or adaptive stream controller). Encoder settings 190 may include resolution, frame rate, quantization level (i.e., what amount of quantization to apply to the stream, scene, or picture), bits/frame, etc.

QoE controller 110 may include various modules to facilitate the control point evaluation process. Such modules generally include an evaluator 170, an estimator 175 and a predictor 180.

Stall Predictor

Predictor 180—which may also be referred to as stall predictor 180—is generally configured to predict a “stalling” bit rate for a media session over a certain “prediction horizon”. Predictor 180 may predict the “stall” bit rate by using some or all of the expected bit rate for a given control point, the amount of transcoded data currently buffered within the system (waiting to be transmitted), the amount of data currently buffered on the client (from the Client Buffer Model module 125), and the current and predicted network throughput.

The “stall” bit rate is the output media bit rate at which a client buffer model expects that playback on the client will stall given its current state and a predicted network throughput, over a given “prediction horizon”. The “stall” bit rate may be used by the evaluator 170 as described herein.

Visual Quality Estimator

Estimator 175—which may also be referred to as visual quality estimator 175—is generally configured to estimate encoding results for a given control point and the associated visual or coding and device impact on QoE for each control point. This may be achieved using a function or model which estimates a QoE metric, e.g. PQS, as well as the associated bit rate.

Estimator 175 may also be generally configured to estimate transmission results for a given control point and the associated stalling or delivery impact on QoE for each control point. This may be achieved using a function or model which estimates the impact of delivery impairments on a QoE metric (e.g. DQS). Estimator 175 may also model, for each control point, a combined or overall score, which considers all of visual, device and delivery impact on QoE.

Evaluator

Evaluator 170 is generally configured to evaluate a set of control points based on their ability to satisfy policy rules and constraints, such as policy rules and constraints 182 and achieve a target QoE for the media session. Control points may be re-evaluated periodically throughout the session.

A change in control points is typically implemented by a change in the quantization level, which is a key factor in determining quality level (and associated bit rate) of the encoded or transcoded video. In some cases, the controller may also change the frame rate, which affects the temporal smoothness of the video as well as the bit rate. In some further cases, the controller may also change the video resolution if permitted by the format, which affects the spatial detail as well as the bit rate.

In some cases, the evaluator 170 detects that network throughput is degraded, resulting in degraded QoE. Current or imminently poor DQS may be detected by identifying client buffer fullness (for example by using a buffer fullness model), TCP retries, RTT, window size, etc. Upon detecting a current or imminently degraded network throughout, the evaluator 170 may select control points with a reduced bit rate to ensure uninterrupted playback, thereby maximizing overall QoE score. A lower bit rate, and accordingly a higher DQS, also may be achievable by allowing a reduced PQS.

In various cases, the control point evaluation is carried out in two stages. A first stage may include filtering of control points based on absolute criteria, such as removing control points that do not meet all constraints (e.g., policy rules and constraints 182). A second stage may include scoring and ranking of the set of the filtered control points that meet all constraints, that is, selecting the best control point based on certain optimization criteria.

In the first stage, control points are removed if they do not meet applicable policies, PQS targets, DQS targets, or a combination thereof. For example, if the operator has specified a minimum frame rate (e.g. 12 frames per second), then points with a frame rate that is less than the specified minimum frame rate will fail this selection.

To filter control points based on PQS, evaluator 170 may evaluate the estimated PQS for the control points based on parameters such as, for example, resolution, frame rate, quantization level, client device characteristics (estimated viewing distance and screen size), estimated scene complexity (based on input bitstream characteristics), etc.

To filter control points based on DQS, evaluator 170 may estimate a bit rate that a particular control point will produce based on similar parameters such as, for example, resolution, frame rate, quantization level, estimated scene complexity (based on input bitstream characteristics), etc. If the estimated bit rate is higher than what is expected or predicted to be available on the network (in a particular sector or network node), the control point may be excluded.

In some cases, evaluator 170 may estimate bit rate based on previously generated statistics from previous encodings at one or more of the different control points, if such statistics are available.

In the second stage, an optimization score is computed for each of the qualified control points that meet the constraints of the first stage. In some cases, the score may be computed based on a weighted sum of a number of penalties. For example, penalties may be assigned based on an operator preference expressed in a policy. For example, an operator could specify a strong, moderate, or weak preference to avoid frame rates below 10 fps. Such a preference can be specified in a policy and used in the computation of the penalties for each control point. In some other cases, other ways of computing a score for the control points may be used.

In cases where the score is computed based on the penalties, various factors determining optimality of each control point in a system may be considered. Such factors may include expected output bit rate, the amount of computational resources required in the system, and operator preferences expressed as a policy. The computational resources required in the system may be computed using the number of output macroblocks per second of the output configuration. In general, the use of fewer computational resources (e.g., number of cycles required) is preferred, as this may use less power and/or allow simultaneous transcoding of more channels or streams.

In various cases, the penalty for each control point may be computed as a weighted sum of the output bit rate (e.g., estimated kilobits per second), amount of computational resources (e.g., number of cycles required, output macroblocks per second, etc.), or operator preferences expressed as policy (e.g., frame rate penalty, resolution penalty, quantization penalty, etc.). This example penalty calculation also can be expressed by way of the following optimization function:

Penalty=W_{b}*Estimated kilobits per second+
W_{c}*Output macroblocks per second+
W_{f}*Frame Rate Penalty+
Wᵣ*Resolution Penalty+
W_{q}*Quantization Penalty

Each part of the penalty may have a weight W determining how much the part contributes to the overall penalty. In some cases, the frame rate, resolution and quantization may only contribute if they are outside the range of preference as specified in a policy.

For example, if the operator specifies a preference to avoid transcoding to frame rates less than 10 fps, the frame rate penalty may be computed as outlined in the pseudo code below:

```
If output frame rate >= 10:
      Frame Rate Penalty = 0
Else:
      If Frame Rate Preference is Strong:
            Frame Rate Penalty = Strong Penalty
      Else If Frame Rate Preference is Moderate:
            Frame Rate Penalty = Moderate Penalty
      Else If Frame Rate Preference is Weak:
            Frame Rate Penalty = Weak Penalty
```

Similarly, if the operator specifies a preference to avoid transcoding to a vertical resolution lower than 240 pixels, the frame rate penalty may be computed as:

```
If output height >= 240 pixels:
      Resolution Penalty = 0
Else:
If Resolution Preference is Strong:
      Resolution Penalty = Strong Penalty
Else If Resolution Preference is Moderate:
      Resolution Penalty = Moderate Penalty
Else If Resolution Preference is Weak:
      Resolution Penalty = Weak Penalty
```

In some cases, the resolution preference may be expressed in terms of the image width. In some further cases, the resolution preferences may be expressed in terms of the overall number of macroblocks.

The strength of the preference specified in the policy, such as Strong/Moderate/Weak, may determine how much each particular element contributes to the scoring of the control points that are not in the desired range. For example, values of the Strong, Moderate, and Weak Penalty values might be 300, 200, and 100, respectively. The operator may specify penalties in other ways, having any suitable number of levels where any suitable range of values may be associated with those levels.

In cases, where the scoring is based on penalties, lower scores will generally be more desirable. However, scoring may instead be based on “bonuses”, in which case higher scores would be more desirable. It will be appreciated that various other scoring schemes also can be used.

Once the various scores corresponding to various candidate control points are determined, the evaluator 170 selects the control point with the best score (e.g., lowest overall penalty).

Reference is next made to FIG. 2B, illustrating a process flow diagram according to an example embodiment. Process flow 200 may be carried out by evaluator 170 of the QoE controller 110. The steps of the process flow 200 are illustrated by way of an example input bit rate with resolution 854×480 and frame rate 24 fps, although it will be appreciated that the process flow may be applied to an input bit rate of any other resolution and frame rate.

Upon receiving the resolution and frame rate information regarding the input bit rate, the evaluator 170 of the QoE controller 110 determines various candidate output resolutions and frame rate. The various combinations of the candidate resolutions and frame rates may be referred to as candidate control points 230.

For example, for the input bit rate with resolution 854×480, the various candidate output resolutions may include resolutions of 854×480, 640×360, 572×320, 428×240, 288×160, 216×120, computed by multiplying the width and the height of the input bit rate by multipliers 1, 0.75, 0.667, 0.5, 0.333, 0.25.

Similarly, for the input bit rate with a frame rate of 24 fps, the various candidate output frame rates may include frame rates of 24, 12, 8, 6, 4.8, 4, derived by dividing the input frame rate by divisors 1, 2, 3, 4, 5, 6.

Various combinations of candidate resolutions and candidate frame rates can be used to generate candidate control points. In this example, there are 36 such control points. Other parameters may also be used in generating candidate control points as described herein, although these are omitted in this example to aid understanding.

At 205, the evaluator 170 determines which of the candidate control points 230 satisfy the policy rules and constraints 282 received from a policy engine, such as the policy engine 115. The control points that do not satisfy the policy rules and constraints 282 are excluded from further analysis at 225. The remaining control points are further processed at 210.

Accordingly, at 210, the QoE controller can determine if the remaining control points satisfy a quality level target (e.g., target PQS). For example, the estimated quality level is received from a QoE estimator, such as the estimator 175. Control points that fail to meet the target quality level are excluded 225 from the analysis. The remaining control points are further processed at 215.

In some cases, the determination of whether or not the remaining control points satisfy the target PQS is made by predicting a PQS for each one of the remaining control points and comparing the predicted PQS with the target PQS to determine the control points to be excluded and control points to be further analyzed.

The PQS for the control points may be predicted as follows. First, a maximum PQS or a maximum spatial PQS that is achievable or reproducible at the client device may be determined based on the device type and the candidate resolution. Here, it is assumed that there are no other impairments and other factors that may affect video quality, such as reduced frame rate, quantization level, etc., are ideal. For example, a resolution of 640×360 on a tablet may yield a maximum PQS score of 4.3.

Second, the maximum spatial PQS score may be adjusted for the candidate frame rate of the control point to yield a frame rate adjusted PQS score. For example, a resolution of 640×360 on a tablet with a frame rate of 12 fps may yield a frame rate adjusted PQS score of 3.2.

Third, a quantization level may be selected that most closely achieves the target PQS given a particular resolution and frame rate. For example, if the target PQS is 2.7 and the control point has a resolution of 640×360 and frame rate of 12 fps, selecting an average quantization parameter of 30 (e.g., in the H.264 codec) achieves a PQS of 2.72. If the quantization parameter is increased to 31 (in the H.264 codec), the PQS estimate is 2.66.

Evaluator 170 can repeat the PQS prediction steps for one or more (and typically all) of the remaining control points. In some cases, one or more of the remaining control points may be incapable of achieving the target PQS.

FIG. 2B is a diagram illustrating a method in accordance with an embodiment of the present invention. A process flow 200 is presented for use with evaluator 170. For example, of the 36 control points, there may be resolution and frame rate combinations that may never achieve the target PQS irrespective of the quantization level. In particular, control points with frame rates of 8 or lower, and all resolutions of 288×160 or below, would yield a PQS that is below the target PQS of 2.7 regardless of the quantization parameter. Evaluator 170 determines which of the control points would never achieve the target PQS, such as, for example, the target PQS of 2.7, and excludes 225 such control points.

At 215, the QoE controller determines if the remaining control points from 210 satisfy a delivery quality target or other such stalling metric. Accordingly, at 215, the QoE controller can determine if the remaining control points satisfy a delivery quality target (e.g., target DQS). The delivery quality target is received from a stall rate predictor, such as predictor 180. The control points that do not satisfy the delivery quality network are excluded 225 from the analysis. The remaining control points are considered at 220.

To determine whether the control points satisfy the delivery target value, a bit rate that would be produced by the remaining control points is predicted. In one example, the following model, based on the resolution, frame rate, quantization level and characteristics of the input bitstream (e.g. the input bit rate) may be used to predict the output bit rate:

bitsPerSecond=InputFactor*((A*log(MBPF)+B)*(e^{-C*FPS}+D))/((E−MBPF*F)^{QP})

InputFactor is an estimate of the complexity of the input content. This estimate may be based on the input bit rate. For example, an InputFactor with a value of 1.0 may mean average complexity. MBPF is an estimate of output macroblocks per frame. FPS is an estimate of output frames per second. QP is the average/typical H.264 quantization parameter to be applied in the video encoding. Values A through F may be constants based on the characteristics of the encoder being used, which can be determined based on past encoding runs with the encoder. One example of a set of constant values for an encoder is: A=−296, B=2437, C=−0.0057, D=0.506, E=1.108, F=2.59220134e-05.

In some cases, control points that have an estimated bit rate that is at or near the bandwidth estimated to be available to the client on the network may be excluded 225 from the set of possible control points. This is because the predicted DQS may be too low to meet the overall QoE target.

At 220, the remaining control points are scored and ranked to select the best control point. The criteria for determining whether a control point is the best may be a penalty based model as discussed herein.

In some embodiments, one or more of 205, 210 and 215 may be omitted to provide a simplified evaluation. For example, in some embodiments, a target QoE may be based on PQS alone, and evaluator 170 may only perform target PQS evaluation, omitting policy evaluation and target DQS evaluation.

Table I illustrates example control points and associated parameter values to illustrate the scoring and ranking that may be performed by the evaluator 170.

TABLE I
Control Points and Associated Parameter Values

| | | | | | Estimated | Output | |
|---|---|---|---|---|---|---|---|
| Control | | | Frame | | Bit Rate | Macroblocks | |
| Point # | Width | Height | Rate | QP | (kbps) | per Second | Estimated PQS |
| 1 | 640 | 360 | 12.0 | 30 | 280 | 11040 | 2.72 |
| 2 | 428 | 240 | 24.0 | 31 | 290 | 10080 | 2.71 |
| 3 | 572 | 320 | 12.0 | 26 | 330 | 8640 | 2.70 |

Control points 1 to 3 in Table I are control points that, for example, meet the policy rules and constraints 282, and target QoE constraints. Evaluator 170 can compute scores (e.g., penalty values) for these remaining control points.

Output macroblocks per second may be computed directly from the output resolution and frame rate based on an average or estimated number of macroblocks for a given quantization level. The penalty values are computed based on the following optimization function discussed herein:

Penalty=W_{b}*Estimated kilobits per second+
W_{c}*Output macroblocks per second+
W_{f}*Frame Rate Penalty+
Wᵣ*Resolution Penalty+
W_{q}*Quantization Penalty

In cases where optimization based solely on bit rate is desired, all the weights other than W_{b} in the optimization function may be set to 0. In that case, the control point with the lowest bit rate would be selected. In the example illustrated in table I, control point 1 would be selected for pure bit rate optimization.

In cases where optimization based on complexity is desired, all the weights other that W_{c} may be set to 0. Since complexity may be determined by the number of output macroblocks per second, the option with the lowest number of macroblocks per second would be selected. In the example illustrated in Table I, control point 3 would be selected for pure complexity optimization.

In cases where a combined bit rate and complexity optimization is desired, both the bit rate and complexity can be taken into account. In this case, all the weights other than W_{b} and W_{c} may be set to 0. Table II illustrates example control points where W_{b} is set to 1 and W_{c} is set to 0.02 to determine a control point with the best balance of bit rate and complexity.

TABLE II
Control Points with W_{b} = 1 and W_{c} = 0.02

| | Estimated | Output | | | |
|---|---|---|---|---|---|
| Control | Bit Rate | Macroblocks | Bit rate | Complexity | Total |
| Point # | (kbps) | per Second | component | component | Penalty |
| 1 | 280 | 11040 | 280 | 221 | 501 |
| 2 | 290 | 10080 | 290 | 202 | 492 |
| 3 | 330 | 8640 | 330 | 173 | 503 |

In this case, control point 2 is determined to have the best balance of bit rate and complexity, as it has the lowest total penalty.

In cases where a combined bit rate and frame rate optimization is desired, both the bit rate and the frame rate preferences can be taken into account. In this case, all the weights other than W_{b} and W_{c} may be set to 0. Table III illustrates example control points where the operator has specified a strong preference to avoid frame rates below 15 fps. In this case, both the W_{b} and the W_{f} may be set to 1 to determine the control point with the best balance of bit rate and frame rate.

TABLE III
Control Points with W_{b} = 1 and W_{f} = 1

| | Estimated | | | | |
|---|---|---|---|---|---|
| Control | Bit Rate | | Bit rate | Frame rate | Total |
| Point # | (kbps) | Frame Rate | component | component | Penalty |
| 1 | 280 | 12.0 | 280 | 300 | 580 |
| 2 | 290 | 24.0 | 290 | 0 | 290 |
| 3 | 330 | 12.0 | 330 | 300 | 630 |

Both the control points 1 and 2 may have a frame rate penalty of 300 applied due to the “strong” preference and the fact that their frame rates are below 15 fps. In this case, control point 2 may be the selected option.

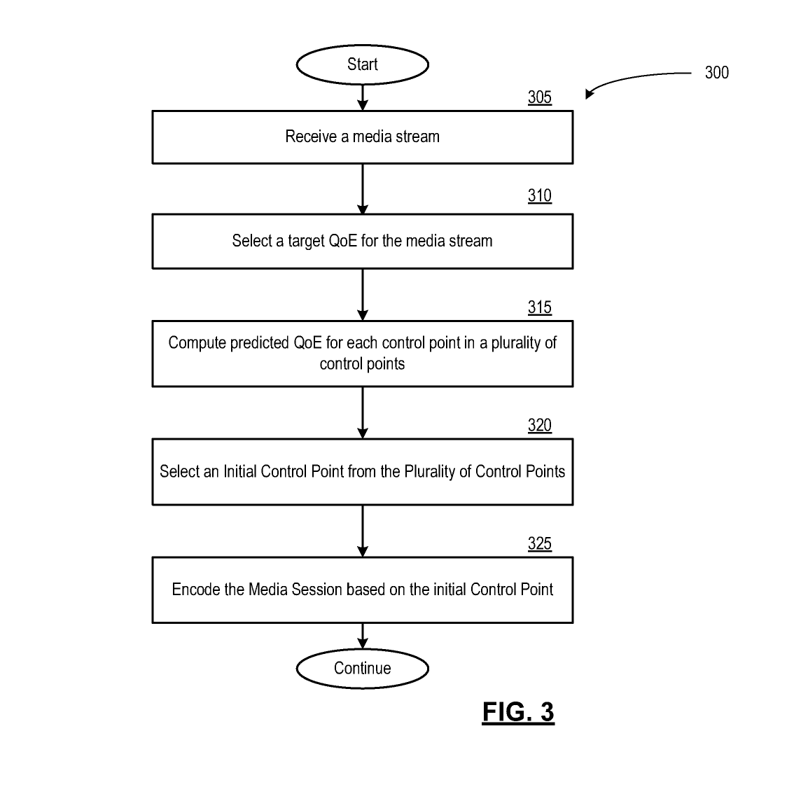

FIG. 3 is a diagram illustrating a method in accordance with an embodiment of the present invention. In particular, a process flow diagram 300 is shown that may be executed by an exemplary QoE controller 110. Process flow 300 begins at 305 by receiving a media stream, for example at the commencement of a media session.

At 310, the control system may select a target quality level—or target QoE—for the media stream. The target QoE may be a composite value computed based on PQS, DQS or combinations thereof. In some cases, the target QoE may be a tuple comprising individual target scores. In general, target QoE may generally be weighted in favor of PQS, since this is easier to control. In some cases, the target QoE may be provided to the QoE controller by the policy engine, or it may be provided by the content or service provider (e.g. Netflix) that is requesting the transcoding service via a web interface or similar. In some other cases, the target QoE may be calculated based on factors such as the viewing device, the content characteristics, subscriber preference, etc. In some further cases, the QoE controller may calculate the target QoE based on policy received from the policy engine. For example, the QoE controller may receive the policy that a larger viewing device screen requires a higher resolution for equivalent QoE than a smaller screen. In this case, the QoE controller may determine the target QoE based on this policy and the device size. It will be appreciated that in some cases the term QoE is not limited to values based on PQS or DQS. In some cases, QoE may be determined based on various one or more other objective or subjective metrics for determining a quality level.

Similarly, a policy may state that high action content, such as, for example, sports, requires a higher frame rate to achieve adequate QoE. The QoE controller may then determine the target QoE based on this policy and the content type.

Likewise, the policy may provide that the subscriber receiving the media session has a preference for better quantization at the cost of lower frame rate and/or resolution, or vice-versa. The QoE controller may then determine the target QoE based on this policy.

At 315, for a plurality of control points, a predicted quality level—or predicted QoE—associated with each control point may be computed as described herein. Each control point has a plurality of transcoding parameters, such as, for example, resolution, frame rate, quantization level, etc. associated with it.

QoE controller may generate a plurality of control points based on the input media session. The incoming media session may be processed by a decoder, such as decoder 150. The media session may be processed at an application and/or a container level to generate input stream statistics, such as the input stream statistics 188. The input stream statistics may be used by the QoE controller to generate a plurality of candidate control points. The plurality of candidate control points may, in addition or alternatively, be generated based on the policy rules and constraints, such as policy rules and constraints 182, 282.

At 320, an initial control point may be selected from the plurality of control points. The initial control point may be selected so that the predicted QoE associated with the initial control point substantially corresponds to the target QoE.

The initial control point may be selected based on the evaluation carried out by evaluator 170. The optimization function model to calculate penalties may be used by the evaluator 170 to select the initial control point as described herein. Selection of an optimal control point may be based on one or more of the criteria such as minimizing bit rate, minimizing transcoding resource requirements and satisfying additional policy constraints, for example, device type, subscriber tier, service plan, time of the day etc.

In various cases, the QoE controller may compute the target QoE and/or the predicted QoE for a media stream in a media session for a range or duration of time, referred to as a “prediction horizon”. The duration of time for which the QoE is predicted or computed may be based on content complexity (motion, texture), quantization level, frame rate, resolution, and target device.

The QoE controller may anticipate the range of bit rates/quality-levels that are likely to be encountered in a session lifetime. Based on this anticipation, the QoE controller may select initial parameters, such as the initial control point, to provide most flexibility over life of the session. In some cases, some or all of the initial parameters selected by the QoE controller may be set to be unchangeable over life of the session.

At 325, the media session is encoded based on the initial control point. The media session may be encoded by an encoder, such as encoder 155.

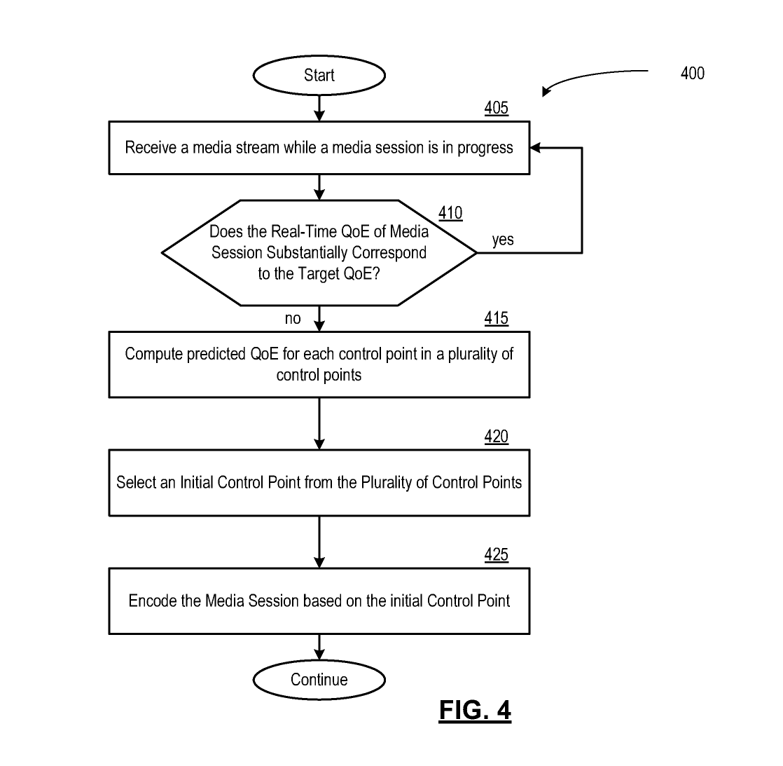

FIG. 4 is a diagram illustrating a method in accordance with an embodiment of the present invention. In particular, a process flow is shown that may be executed by an exemplary QoE controller 110. Process flow 400 begins at 405 by receiving a media stream, for example while a media session is in progress. In some cases, process flow 400 may continue from 325 of process flow 300 in FIG. 3.

At 410, the QoE controller determines whether the real-time QoE of the media session substantially corresponds to the target QoE. The target QoE may be provided to the QoE controller by a policy engine, such as the policy engine 115. The target QoE may be set by the network operator. In addition, or alternatively, the target QoE may be calculated by the QoE controller as described herein.

If the real-time QoE substantially corresponds to the target QoE, no manipulation of the media stream need be carried out, and the QoE controller can continue to receive the media streams during the media session. However, if the real-time QoE does not substantially correspond to the target QoE, the process flow proceeds to 415.

At 415, for a plurality of control points, a predicted QoE associated with each control point may be re-computed using a process similar to 315 of process flow 300. The predicted QoE may be based on the real-time QoE of the media stream. In various cases, the interval for re-evaluation or re-computation is much shorter than the prediction horizon used by the QoE controller.

At 420, an updated control point may be selected from the plurality of control points using a process similar to 320 of process flow 300. The updated control point is selected so that the predicted QoE associated with the updated control point substantially corresponds to the target QoE. The updated control point may be selected based on the evaluation carried out by evaluator 170. The optimization function model to calculate penalties may be used by the evaluator 170 to select the updated control point.

At 425, the media session may be encoded based on the updated control point. The media session may be encoded by an encoder, such as encoder 155. Accordingly, if the media session was initially being encoded using an initial control point, the encoder may switch to using an updated control point following its selection at 420.

As described herein, the target and the predicted QoE computed in process flows 300 and 400 may be based on the visual presentation quality of the media session, such as that determined by a PQS score. In some cases, the target and the predicted QoE may be based on the delivery network quality, such as that determined by the DQS score. In some further cases, the target and the predicted QoE correspond to a combined presentation and network delivery score, as determined by CQS.

In cases where the target and the predicted QoE are based on the PQS, the elements related to network delivery may be optional. For example, in such cases, the network resource model 120 and the client buffer model 125 of system 100 may be optional. Similarly, predictor 180 of the QoE controller 110 may also be optional.

In cases where the target and the predicted QoE are based on the combined quality score, i.e. CQS, the target PQS and target DQS may be combined into the single target score or CQS. The CQS may be computed according to the following formula, for example:

CQS=CO+C1*(PQS+DQS)+C2*(PQS*DQS)+C3*(PQŜ2)*(DQŜ2)

In one example, the values C0, C1, C2, C3 and C4 may be constants having the following values: C0=1.1664, C1=−0.22935, C3=0.29243 and C4=−0.0016098. In some other cases, the constants may be given different values by, for example, a network operator. In general, CQS scores give more influence to the lower of the two scores, namely PQS and DQS.

Various embodiments are described herein in relation to video streaming, which will be understood to include audio and video components. However, the described embodiments may also be used in relation to audio-only streaming, or video-only streaming, or other multimedia streams including an audio or video component.

In some cases, audio and video streams may both be combined to compute an overall PQS, for example, according to the following formula:

(Video_weight*(Video_{—}PQS^{p})+Audio_weight*(Audio_{—}PQS^{p}))^{(1/p)}

Video_weight and Audio_weight may be selected so that their sum is 1. Based on the determination regarding the importance of the audio or the video, the weights may be adjusted accordingly. For example, if it is decided that video is more important, then the Video_weight may be ⅔ and the Audio_weight may be ⅓.

The value of p may determine how much influence the lower of the two input values has on the final score. A value of p between 1 and −1 may give more influence to the lower of the two inputs. For example, if a video stream is very bad, then the whole score may be very bad, no matter how good the audio. In various cases, p=−0.25 may be used for both the audio and the video streams.

The described embodiments generally enable service providers to provide their subscribers with assurance that content they access will conform to one or more agreed upon quality levels, permitting creation of pricing models based on the quality of their subscribers' experiences. The described embodiments also enable service providers to provide content providers and aggregators with assurances that their content will be delivered at one or more agreed upon quality levels, permitting creation of pricing models based on an assured level of content quality. In addition, the described embodiments enable service providers to deliver the same or similar video quality across one or more disparate media sessions in a given network location.

While the foregoing description has focused on the control of a single media session, multiple media sessions generated in response to streaming media from media server 30 or delivered via access network 15 can be controlled contemporaneously via generation of encoder settings 190 corresponding to multiple concurrent sessions. For example, the system 100 can operate to control the transmission and quality of the streaming media provided in a number of concurrent media sessions in accordance with session policies that are established and updated based on actual and predicted network performance, the number of concurrent media sessions, subscription information pertaining to the users of the client devices 20 and/or other criteria.

In operation, the estimator 175 and predictor 180 operate from media session data in the form of input stream statistics 188 and output stream statistics 192 and network data processed by client buffer model 125 in the form of client buffer statistics and further network statistics 184 from network resource model 120 to generate session quality data that includes a plurality of session quality parameters corresponding to a plurality of media sessions being monitored. The policy engine 115 generates session policy data in the form of policy rules and constraints 182. In particular, the session policy data includes a plurality of quality targets corresponding to the plurality of media sessions. The evaluator 170 generates transcoder control data based on the session quality data and the session policy data. The transcoder control data can include encoder settings 190 that control encoding and/or transcoding of the streaming media in the plurality of media sessions.

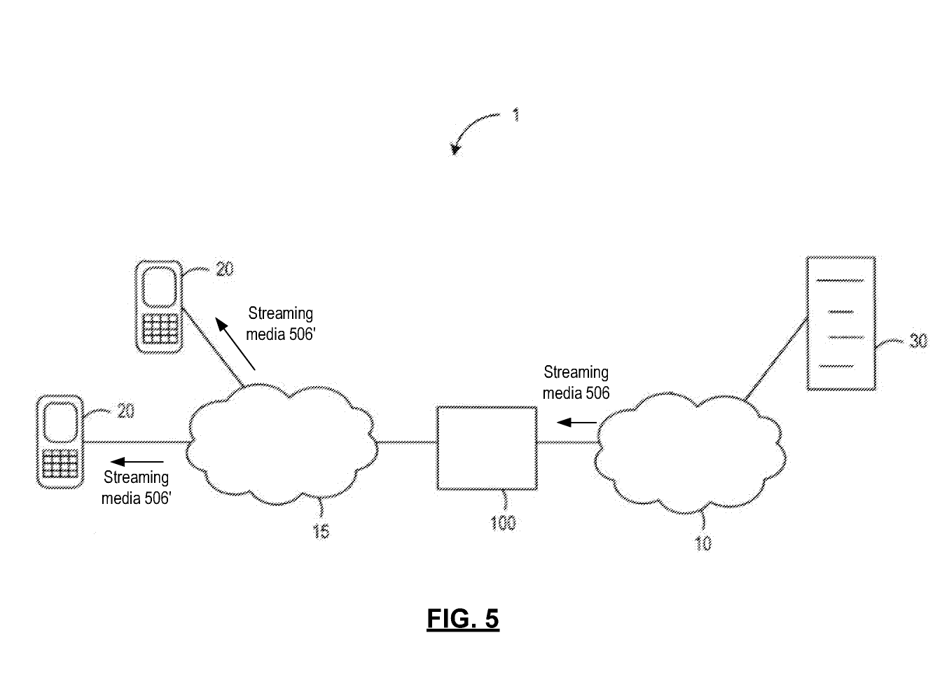

Further details including several optional functions and features are described in conjunction with FIGS. 5-8 that follow.

FIG. 5 is a schematic block diagram illustrating a system in accordance with an embodiment of the present invention. In particular, a system is shown that includes components described in conjunction with FIGS. 1-4 that are referred to by common reference numerals. Streaming media 506 from one or more media servers 30 includes multiple concurrent media sessions that are delivered to a plurality of client devices 20. As discussed, the system 100 adjusts or otherwise controls the quality of one or more of the media sessions in the streaming media 506 for provision as streaming media 506′ to a plurality of client devices 20 via access network 15.

The streaming media 506 can include one instance of content that is delivered as streaming media 506′ to each of the client devices 20 via a plurality of media sessions or multiple different instances of content that are delivered from one or more media servers 30 to corresponding ones of the plurality of client devices 20 via a plurality of media sessions. The streaming media 506 can include audio and/or video and other streaming media.

Consider an example of where the streaming media 506 includes streaming video. The network 15 can be an internet protocol (IP) network that operates via a reliable transport protocol such as Transmission Control Protocol (TCP). The system 100 operates in conjunction with the networks 10 and 15 and the media servers 30 to measure or otherwise estimate the quality via Quality of Experience (QoE) or other quality measure associated with the playback of the streaming media at each of the client devices 20. In addition, the system 100 operates to allocate network resources, i.e. to control the transmission and quality of the streaming media 506′ for playback to the media clients in accordance with session policies that are established and updated based on actual and predicted network performance, the number of concurrent media sessions, subscription information pertaining to the users of the client devices 20 and/or other criteria.

For example, this system 100 enables service providers to provide their subscribers with assurance that content they access will conform to one or more agreed upon quality levels, permitting creation of pricing models based on the quality of their subscriber's experiences. This system further can enable service providers to provide content providers and aggregators with assurance that their content will be delivered at one or more agreed upon quality levels, permitting creation of pricing models based on an assured level of content quality. In addition, this system can enable service providers to deliver the same/similar video quality across one or more disparate media sessions in a given network location and across common subscriber/service tiers. The quality can be maximized across all subscribers sharing a limited amount of bandwidth. Quality reductions can be implemented equitably as more video sessions join, supporting more subscribers at given QoE or higher QoE per subscriber. In addition, this system can enable service providers to prevent wasting limited network resources on media sessions that would result in an unacceptable quality of experience.

In other examples of operation, the system is able to allocate the network bandwidth and/or other network resources on a particular link shared by one or more media sessions to control these media sessions in order to provide one or more discrete QoE/quality levels to media sessions, regardless of content complexity, i.e. supporting tiered services and/or other considerations. The system can accommodate a new media session on a link shared by one or more media sessions by re-allocating network resources among all media sessions, such that QoE/quality level is equally reduced, regardless of content complexity. Further, the system can accommodate reduction in capacity on a link shared by one or more media sessions by re-allocating network resources among all media sessions such that QoE/quality level is equally reduced, regardless of content complexity.

In one mode of operation, the system 100 provides a controller that normalizes the media sessions by setting the target media session characteristics to a common quality target. For example, the system 100 can strive to equalize the QoE or other qualities for each media session, even in conditions when the media sessions are characterized by differing content complexities, the client devices 20 have differing capabilities, etc. In response to these policies, a controller of the system 100 can control the bandwidth in streaming media 506′ for each of the media sessions. In particular, the bandwidth of the streaming media sessions can be controlled in accordance with a particular allocation of the available network bandwidth that provides the same QoE/quality, substantially the same QoE/quality or some other equitable allocation of QoE/Quality among the media sessions.

In a further mode of operation, the system 100 can adapt to changes in the number of media sessions. For example, when a new media session is added and the number of media session increases, the system 100 can set each of the session quality targets to a new quality target that is reduced from the prior quality target. In a further example, when a media session ends and the number of media sessions decreases, the system can set each of the session quality targets to a new quality target that is increased from the prior quality target. It should be noted that changes can be made to the target qualities within the lifetimes of each of the sessions. Updates can be scheduled to take place either periodically or as conditions warrant.

The media sessions can be characterized by differing subscriber/service tiers. For example, subscribers can be ranked by subscription tiers at different levels such as diamond, platinum, gold, silver, bronze, etc. In this case, higher tier subscribers may be entitled to higher quality levels than lower tier subscribers. In a further example, subscribers may select (and optionally pay for) a particular service tier for a media session such as high definition, standard definition or other service levels. In this case, media sessions corresponding to higher tier services may be entitled to higher quality levels than lower tier services. In these cases, the system 100 can generate the plurality of quality targets based on the subscriber/service tier corresponding to each of the plurality of media sessions. In particular, the system can set the quality targets to a common quality target (the same target) for each of media sessions having the same subscriber tier. Further, the common quality target for each of the subscriber/service tiers can be selected to ensure that higher tiers receive higher quality than lower tiers.

In further modes of operation, the media sessions can be characterized by differing media sources and/or differing content types. In one mode of operation, media sessions corresponding to some media sources may be entitled to higher quality levels than other media sources. For example, a network provider could assign a quality level for all traffic associated with a particular media source (e.g. Netflix, Amazon Prime Instant Video, Hulu plus, etc.) and equalize the quality level for that source. In this fashion, the network provider can provide tiers of service based on the particular media sources, with high tier sources, medium tier sources and lower tier sources. In this fashion, the system 100 can maintain higher quality for preferred sources, selectively deny service to lower tier sources to maintain quality for higher tier media sources, apply quality reductions or increases by media source tier, and/or provide quality reductions first to lower tier sources while maintaining consistent quality to higher tier sources, etc.

In another mode of operation, the media sessions corresponding to some content types may be entitled to higher quality levels than other content types. For example, quality tiers may be applied to different content types, such as free media content, paid media content, short video clips, advertisements, broadcast video programming, sports programming, news programming and/or video on demand programming. For example, a network provider could assign a quality level for all traffic associated with a particular media type (e.g. feature length video on demand) and equalize the quality level for that source. In this fashion, the network provider can provide tiers of service based on the particular content type, for example, with high tier content, medium tier content and lower tier content. In this fashion, the system 100 can maintain higher quality for preferred content, selectively deny service to lower tier content to maintain quality for higher tier media content types, apply quality reductions or increases by media content tier, and/or provide quality reductions first to lower tier content while maintaining consistent quality to higher tier content, etc.

In yet another mode of operation, the system 100 adapts to changes in current or predicted network load and/or the presence or absence of congestion. For example, when network load increases or is predicted to increase, the system 100 can set each of the quality targets to a new quality target that is reduced from the prior quality target. In a further example, when network load decreases or is predicted to decrease, the system 100 can set each of the quality targets to a new quality target that is increased from the prior quality target. The quality targets can be different for differing subscriber/service/source/content tiers and can be increased or decreased in a corresponding or proportional fashion in response to changes in current and/or predicted network load and/or the presence or absence of congestion.

When insufficient bandwidth is available to service a new request—e.g. when bandwidth reduction would result in quality levels falling below minimum or target levels for the media sessions or the media sessions in the lowest tiers, the system 100 may deny service to the new session. The primary purpose of this action is to save bandwidth on a shared link in deference of other ongoing sessions, optionally based on subscriber/service/source/content tiers, so that current sessions are able to maintain a minimum or target level of QoE. The session denial action may be associated with a low-bandwidth communication sent to the subscriber, which may be in the form of a video message or a text message or other format, to indicate that a media session has been denied due to network congestion or other situation.

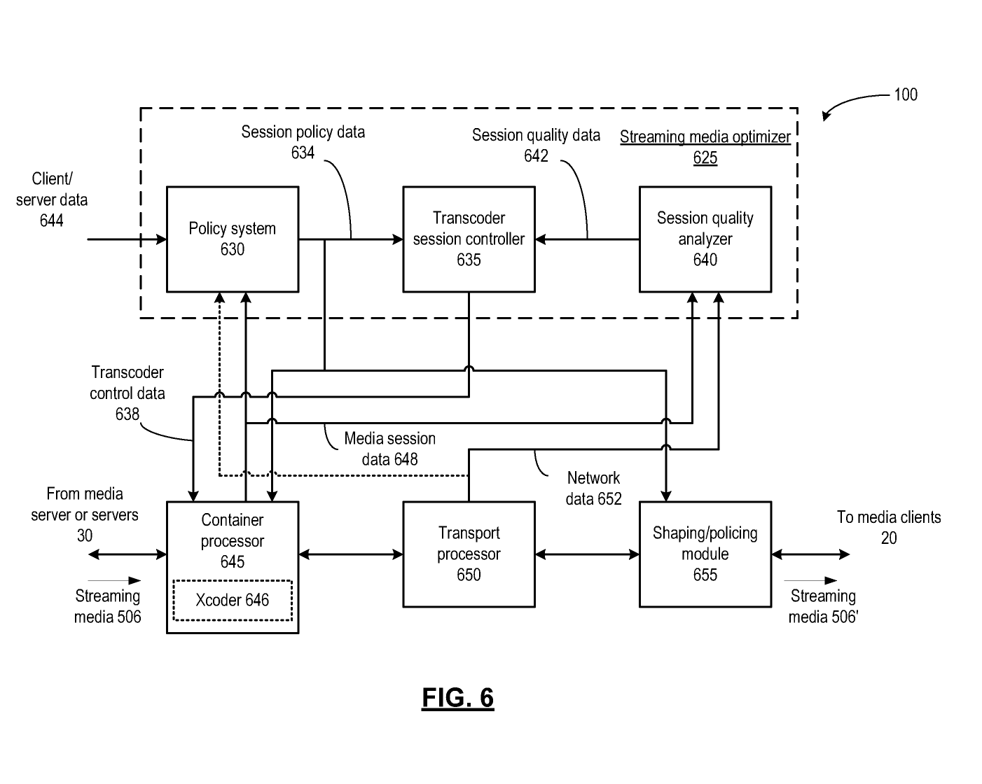

Details relating to further embodiments of the system 100 including several optional functions and features are described in conjunction with FIGS. 6-8 that follow.

FIG. 6 is a schematic block diagram of a system including a streaming media optimizer in accordance with an embodiment of the present invention. In particular, another embodiment of system 100 is shown that includes a streaming media optimizer 625 having a policy system 630, transcoder session controller 635 and session quality analyzer 640. The system further includes a container processor 645, transport processor 650 and shaping/policing module 655. The system performs in a similar fashion to the embodiment shown in conjunction with FIG. 2A. In an embodiment, transcoder session controller 635 can perform similar functions as evaluator 170. Session quality analyzer 640 can perform similar functions as estimator 175, predictor 180 and client buffer module 125. Transcoder 646 can be similar to transcoder 105. Policy system 630 can perform similar functions to policy engine 115 and transport processor 650 can perform similar functions to network resource module 120. In addition, the system of FIG. 6 can perform additional functions and features as described below.

In operation, the container processor 645 receives streaming media 506 that includes multiple media sessions or otherwise receives media content to be streamed as streaming media 506 along the transport path between the media server 30 and the plurality of client devices 20. The container processor 645 generates media session data 648. The container processor 645 includes a transcoder 646 that is controlled in response to the transcoder control data 638. In particular the transcoder control data 638 is used by transcoder 646 to control transcoding of the streaming media 506 in the plurality of media sessions.

For example, the container processor 645 may parse, analyze and process media containers such as FLV, MP4, ASF and the like that are present in the streaming media 506. The container processor 645 analyzes these media containers and associated metadata to generate media session data 648 used in QoE calculations by session quality analyzer 640. The media session data 648 can contain frame information such as frame arrival, frame type and size, certain statistics about the source and the transcoded bit streams including the current resolution, frame rate, quantization parameters, bit rates produced by the transcoder as well as the current decode times for these streams.

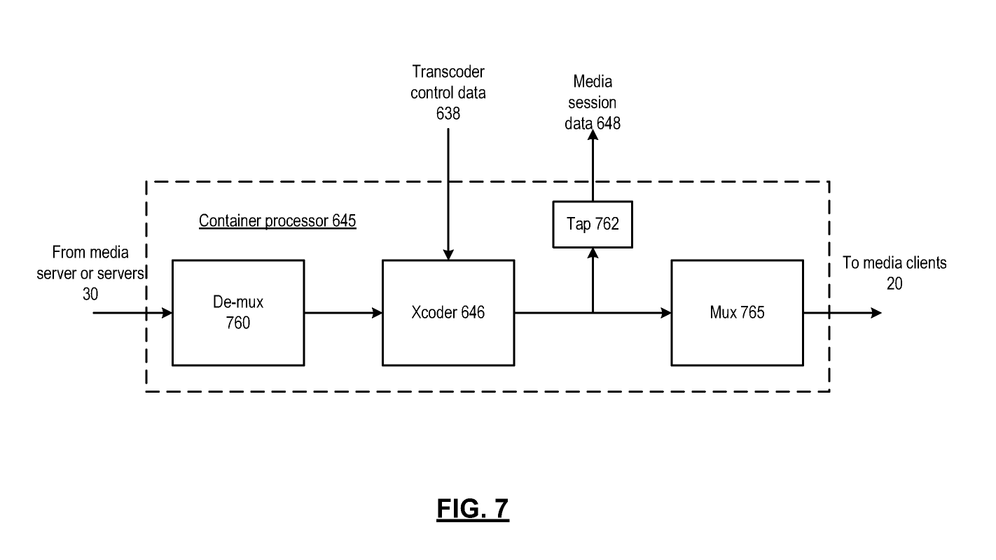

In an embodiment, the media session data 648 is generated without producing an explicit video output. When a transcode control is required in a media session to adjust the frame rate, bit rate, resolution, or to adjust other audio, video or media parameters, the container processor 645 encapsulates the functions of demultiplexer 760, transcoder 646 and re-multiplexing via multiplexer 765 as shown in FIG. 7. In particular, FIG. 7 presents a schematic block diagram of a container processor 645 in accordance with an embodiment of the present invention. In this embodiment, the container processor 645 can accept transcoding control updates in the form of transcoder control data 638 from the transcoder session controller 635. The transcoder control data 638 can include settings or changes to bit rate, frame rate, resolution, scale, and explicit QP values, driven by the transcoder session controller 635 to, for example, meet a target QoE.

The tap 762 can include a passive tap that is used to split and replicate traffic directly from a network link in the network path between the media server 30 and the client devices 20. This approach offers a non-intrusive method for replicating the container traffic and producing the media session data 648. While a downstream path from media server 30 to the client devices 20 is shown, in other cases the tap 762 can be configured to a physical port on which traffic arrives as upstream and/or downstream depending on the feed from the passive tap to indicate the direction of the data through the network. In an alternative configuration, the tap 762 can be coupled to receive data via a port mirroring function of Ethernet switches or routers to replicate the media session data 648 from the network traffic. This approach has the advantage of being relatively simple to enable via configuration within existing deployed network elements within the backhaul and core network. In this approach, the subscriber and internet IP address masks can be specified in order for the session quality analyzer 640 to determine the direction of the traffic on each subnet.

While the media session data 648 has been described above as corresponding to parsing of the container layer of the streaming media 506, some media session data 648 can optionally be generated by container processor 645 from application data corresponding to the application layer of the streaming media 506 or other layers of the protocol stack. In particular, the media session data 648 can also include other data such as subscriber tiers, service tiers pertaining to the media session, other subscriber and service information such as media client data that indicates information on the configuration and/or capabilities of the media player and display device used by each of the client devices 20, player command data that indicates pause, play, seek, switch, fast forward, rewind, skip and other commands, information relating to the media server 30 or other source information, requests for content and information on the type and number of current media sessions included in the media stream that can be used by the policy system 630.

In addition or in the alternative, subscriber data 644 can optionally be provided from a subscriber profile repository (SPR), a Policy Charging and Rules Function (PCRF) server and or from other sources. In particular, the subscriber data 644 can include subscriber tiers, client device, service levels, quotas and policies specific to the user and/or a subscription tier. The subscriber data may be accessed via protocols such as Diameter, Lightweight Directory Access Protocol (LDAP), web services or other proprietary protocols. Subscriber data may be enhanced with subscriber information available to the media session control system 100, such as a usage pattern associated with the subscriber, types of multimedia contents requested by the subscriber in the past, the current multimedia content requested by the subscriber, time of the day the request is made and location of the subscriber making the current request, etc.

Returning to FIG. 6, the transport processor 650 processes the streaming media 506 as output from the container processor 645. The transport processor 650 may parse the transport layer (e.g., TCP, UDP, etc.) and generate network data 652. The network data 652 can include a current network bit rate and a predicted network bit rate. In particular, the transport processor 650 generates network data 652 that indicates the successful and/or unsuccessful delivery of video data to each of the client devices 20. In an embodiment, the transport processor 650 can keep track of when packets are sent and received, including when packets are acknowledged (or lost) by the client device 20 to, for example, permit modeling of the client video buffer via session quality analyzer 640. The transport processor 650 may also report on past and predicted network/transmission bit rate, based on an accumulation of packets and/or byte counts for all media sessions.

The session quality analyzer 640 receives media session data 648 and network data 652 corresponding to the plurality of media sessions of streaming media 506. In operation, the session quality analyzer 640 uses the network data 652 and media session data 648 as control input to a state machine, look-up table or other processor to determine the session policy data 634. The session quality data 642 includes a plurality of session quality parameters corresponding to the plurality of media sessions of streaming media 506. The session quality parameters can include current QoE scores and bit rates, predictions of future QoE scores and bit rates, and predicted stalling bit rates for each of the media sessions and corresponding client devices 20.

The session quality analyzer 640 can generate session quality data 642 in the form of statistics and QoE measurements for media sessions, and also estimates of bandwidth required to serve a client request and media stream at a given QoE.

While this session quality data 642 is shown as being used by transcoder session controller 635, the session quality analyzer 640 may also use and may make these values available, as necessary, to other modules of the system. Examples of statistics that may be generated include bandwidth, site, client device type, media player type including audio and video codec, resolution, bit rate, frame rate, clip duration, streamed duration, channels, bit rate, sampling rate, and the like. Current and predicted QoE measurements can include delivery QoE, presentation QoE, and combined QoE. The raw inputs used for statistics and QoE measurements can be extracted from the media session data 648 and network data 652 at various levels, including the transport and media container levels and optionally the application layer and/or other layers of the protocol stack.

In one mode of operation, the session quality analyzer 640 implements a player buffer model that estimates the amount of data in the client's playback buffer at any point in time in each of the current media sessions. It uses these estimates to model location, duration and frequency of stall events. This module may calculate frame fidelity and an associated visual quality score, e.g. a presentation quality score, for one or more possible transcoder configurations. This may be achieved using a function which, for a given resolution, frame rate, and client device 20, estimates either QP for given bit rate or vice versa. The calculation may also consider various statistics observed thus far in each media session. This function may be computed for one or more configurations over one or more future time intervals. Using this expected bit rate, as well as the amount of transcoded data buffered within the system (waiting to be transmitted) this module may predict the “stall” bit rate. The “stall” bit rate is the transcoded media bit rate at which a buffer model expects that playback on the client device 20 will stall given its current state and a predicted network bandwidth, over a given time interval.

The session quality analyzer 640 can also predict the impact of stalling QoE, e.g. using a metric such as Delivery Quality Score (DQS). Therefore, for a given transcoder configuration (resolution, frame rate, bit rate) and client buffer state, the session quality analyzer 640 can estimate an expected visual quality score as well as the stalling likelihood and associated impact. This module can therefore estimate a combined, overall, QoE score for each session for any possible transcoder configuration. Note that in addition to predicting future QoE and bit rates, this module also monitors similar, actual, statistics as observed over the course of the session, such as actual quality scores, bit rates, etc.

The policy system 630 generates session policy data 634 that includes a plurality of quality of experience targets corresponding to the plurality of media sessions. In operation, the policy system 630 uses the media session data 648 as control input to a state machine, look-up table or other processor to determine session policy data 634. In particular, the policy system 630 determines policies and targets for detected media sessions, which can be used by transcoder session controller 635 in determining a transcode action, in shaping/policing actions by the shaping/policing module 655 in managing the bandwidth of a media session and further in session denial actions by container processor 645 in denying service in response to a new session request.

In an embodiment, the policy system 630 may be configurable by an operator of network 10 to establish, for example, target media session characteristics for the plurality of media sessions as well as acceptable ranges for these media session characteristics. For transcode actions, the policy system 630 notifies the transcoder session controller 635 of session policy data 634 via a messaging channel. Transcode action may be scoped or constrained by one or more individual or aggregate media session characteristics. For example, the session policy data can include for each media session: target, minimum and maximum QoEs; target, minimum and maximum bit rates; target, minimum and maximum resolution; target, minimum and maximum frame rate; and/or other quality policies.

In an embodiment, the policy system 630 operates to set and adapt the target media session characteristics based on media session data 648 that indicates a number of concurrent media sessions. In one mode of operation, the policy system 630 normalizes the media sessions by setting the target media session characteristics to a common quality target. For example, the policy system 630 can strive to equalize the QoE or other quality for each media session, even in conditions when the media sessions are characterized by differing content complexities, the client devices 20 have differing capabilities, etc. In response to these policies, the transcoder session controller 635 and/or the shaping/policing module 655 can control the bandwidth in streaming media 506′ for each of the media sessions. In particular, the bandwidth of the streaming media sessions can be controlled in accordance with a particular allocation of the available network bandwidth that provides the same QoE/quality, substantially the same QoE/quality or some other equitable allocation of QoE/Quality among the media sessions.

In a further mode of operation, the policy system 630 can adapt to changes in the number of media sessions indicated by the media session data 648. For example, when a new media session is added and the number of media session increases, the policy system 630 can generate the session policy data 634 to set each of the plurality of quality targets to a new quality target that is reduced from the common quality target. In a further example, when a media session ends and the number of media session decreases, the policy system 630 can generate the session policy data 634 to set each of the plurality of quality targets to a new quality target that is increased from the common quality target. It should be noted that changes can be made to the target qualities within the lifetimes of each of the sessions. Updates can be scheduled to take place either periodically or as conditions warrant.

As previously discussed, the media session data 648 can indicate a particular subscriber/service tier of a plurality of subscriber/service tiers corresponding to each of the plurality of media sessions. For example, subscribers can be ranked by subscription tiers at different levels such as diamond, platinum, gold, silver, bronze, etc. In this case, higher tier subscribers may be entitled to higher quality levels than lower tier subscribers. In a further example, subscribers may select (and optionally pay for) a particular service tier for a media session such as extremely high definition, very high definition, high definition, standard definition or other service levels. In this case, media sessions corresponding to higher tier services may be entitled to higher quality levels than lower tier services. In these cases, the policy system 630 can generate the plurality of quality targets based on the subscriber/service tier corresponding to each of the plurality of media sessions. In particular, the policy system 630 can generate the session policy data 634 to set the quality targets to a common quality target for each of the media sessions having the same subscriber tier. Further, the common quality target for each of the subscriber/service tiers can be selected to ensure that higher tiers receiver higher quality than lower tiers.

In yet another mode of operation, the policy system 630 optionally receives network data from the transport processor 650 and adapts to changes in current or predicted network congestion. For example, when network congestion increases or is predicted to increase, the policy system 630 can generate the session policy data 634 to set each of the quality targets to a new quality target that is reduced from the prior quality target. In a further example, when network congestion decreases or is predicted to decrease, the policy system 630 can generate the session policy data 634 to set each of the quality targets to a new quality target that is increased from the prior quality target. The quality targets can be different for differing subscriber/service tiers and can be increased or decreased in a corresponding or proportional fashion in response to changes in current and/or predicted network congestion.

For shaping/policing actions, the policy system 630 notifies the shaping/policing module 655 via session policy data 634 to manage the bandwidth of the media sessions in order to achieve a target QoE in the streaming media 506. This action is most effective for media sessions that use adaptive streaming protocols (e.g. Netflix, HLS). The same scenario applies for these sessions as for transcode actions above, but the number of discrete bit rate and QoE levels that are achievable may be limited based on the encodings available on the media source.

For session deny actions, the policy system 630 notifies the container processor 645 via session policy data 634 to disallow a media session. In this embodiment, the media session data 648 includes a new session request from a client device. When insufficient bandwidth is available to service the request—e.g. when bandwidth reduction would result in quality levels falling below minimum or target levels for the media sessions or the media sessions in the lowest tiers, the policy system 630 can generate session policy data 634 that indicates that the request for a new session should be denied. The primary purpose of this action is to save bandwidth on a shared link in deference of other ongoing sessions, so that those sessions are able to maintain a minimum or target level of QoE. The session denial action may be associated with a low-bandwidth communication sent to the subscriber, which may be in the form of a video message, to indicate that a media session has been denied due to network congestion or other situation.

The controller such as evaluator 170 or transcoder session controller 635 generates control data, based on the session quality data 642 and the session policy data 634 to allocate network resources to control the streaming media in the plurality of media sessions. In an embodiment, the transcoder control data 638 is generated to control the transcoder 646 in accordance with the transcode actions discussed above. The transcoder session controller 635 performs the dynamic control of the transcoder 646 to conform to quality targets and constraints set by policy system 630. In operation, the transcoder session controller 635 uses the session policy data 634 and the session quality data 642 as control input to a state machine, look-up table or other processor to determine transcoder control data 638. The transcoder control data 638 can be in the form of transcoding parameters for transcoder 646 that are determined to achieve a specific target QoE/quality level for the media session for the particular client device 20 and the current conditions. In particular, the transcoder control data 638 can include a set of parameters and associated quality level such as a quantization level, resolution, frame rate and one or more other quality metrics.

The transcoder session controller 635 can re-evaluate and update the transcoder control data 638 throughout a media session, either periodically or as warranted in response to changes in either the session policy data 634 or session quality data 642. The interval for re-evaluation can be much shorter than the prediction horizon used in the session quality analyzer. This permits setting QoE targets at beginning of a media session but also changing them throughout session lifetime. A change in control point is typically implemented by a change in the quantization level, which is a factor in determining the output bit rate vs. output quality of the transcoded video. Under some circumstances, the transcoder session controller 635 may also change the frame rate, which affects the temporal quality of the video as well as the bit rate. Under some circumstances, the transcoder session controller 635 may also change the video resolution, which affects the spatial detail as well as the bit rate.

In one example of operation, the transcoder control data 638 can be used to reduce the quality of experience for one or more of the media sessions to equalize the quality of experience either by subscriber/service tier or across the board, or other wise to adapt to current or predicted network congestion. In an embodiment, the transcoder session controller 635 generates transcoder control data 638, based on the session quality data 642 to reduce the quality of the plurality of media sessions (or the sessions in each subscriber/service tier) equally when the network data 652 indicates a reduction in network performance.

While the description above has focused on allocating network resources to the media sessions via transcoder control data 638, other control mechanisms can be employed. The shaping/policing module 655 includes a controller such as a state machine or other processor that implements shaping and policing tools to allocate network resources by dropping or queuing packets that would exceed a committed rate. This module may be configured to apply a specific policer or shaper to a specific subset of traffic, as governed by session policy data 634, to achieve a target QoE. Shaping can typically be applied on TCP data traffic, since TCP traffic endpoints (the client and server) will inherently back-off due to TCP flow control features and self-adjust to the committed rate.

In a further mode of operation, the media sessions can be characterized by differing media sources and/or differing content types. In one mode of operation, media sessions corresponding to some media sources may be entitled to higher quality levels than other media sources. For example, a network provider could assign a quality level for all traffic associated with a particular media source (e.g. Netflix, Amazon Prime Instant Video, Hulu plus, etc.) and equalize the quality level for that source. In this fashion, the network provider can provide tiers of service based on the particular media sources, with higher tier sources, medium tier sources and lower tier sources. In this fashion, the system 100 can maintain higher quality for preferred sources, selectively deny service to lower tier sources to maintain quality for higher tier media sources, apply quality reductions or increases by media source tier, and/or provide quality reductions first to lower tier sources while maintaining consistent quality to higher tier sources, etc.

In another mode of operation, the media sessions corresponding to some content types may be entitled to higher quality levels than other content types. For example, quality tiers may be applied to different content types, such as free media content, paid media content, short video clips, advertisements, broadcast video programming, sports programming, news programming and/or video on demand programming. For example, a network provider could assign a quality level for all traffic associated with a particular media type (e.g. feature length video on demand) and equalize the quality level for that source. In this fashion, the network provider can provide tiers of service based on the particular content type, with higher tier content, medium tier content and lower tier content. In this fashion, the system 100 can maintain higher quality for preferred content, selectively deny service to lower tier content to maintain quality for higher tier media content types, apply quality reductions or increases by media content tier, and/or provide quality reductions first to lower tier content while maintaining consistent quality to higher tier content, etc.

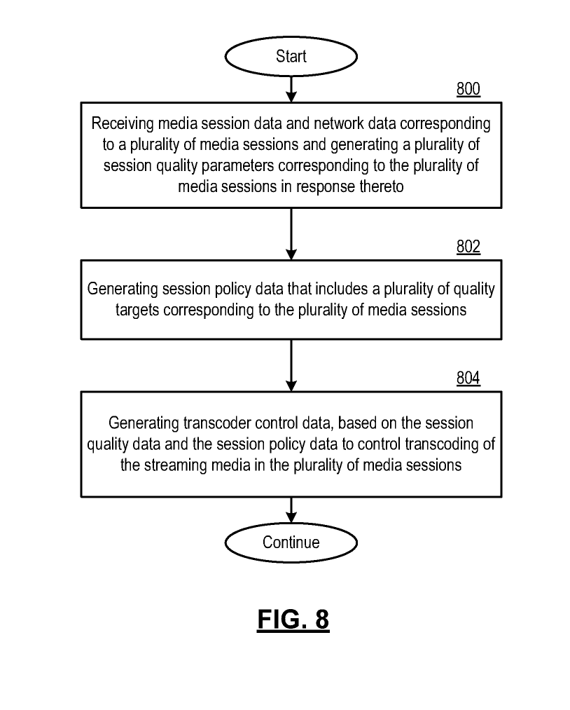

FIG. 8 is a diagram illustrating a method in accordance with an embodiment of the present invention. In particular a method is presented for use in conjunction with one or more functions and features described in conjunction with FIGS. 1-7. Step 800 includes receiving media session data and network data corresponding to a plurality of media sessions and generating session quality data that includes a plurality of session quality parameters corresponding to the plurality of media sessions, in response thereto. Step 802 includes generating session policy data that includes a plurality of quality targets corresponding to the plurality of media sessions. Step 804 includes generating transcoder control data, based on the session quality data and the session policy data to control transcoding of the streaming media in the plurality of media sessions.

In an embodiment, the media session data indicates a number of concurrent media sessions corresponding to the plurality of media sessions and the session policy data is generated based on the number of concurrent media sessions. The plurality of media sessions can be characterized by at least two differing content complexities and the session policy data can be generated to set each of the plurality of quality targets to a common quality target. The session policy data can be generated to reduce each of the plurality of quality targets equally from the common quality target when the number of concurrent media sessions increases. The transcoder control data can be generated to control the transcoding of the streaming media in the plurality of media sessions to reduce a quality of experience for each of the plurality of media sessions equally when the network data indicates a reduction in network performance. The media session data can indicate a particular subscriber tier of a plurality of subscriber tiers corresponding to each of the plurality of media sessions and the plurality of quality targets can be generated based on the subscriber tier corresponding to each of the plurality of media sessions. The session policy data can be generated to set the plurality of quality targets to a common quality target for each of the plurality of media sessions having the subscriber tier.

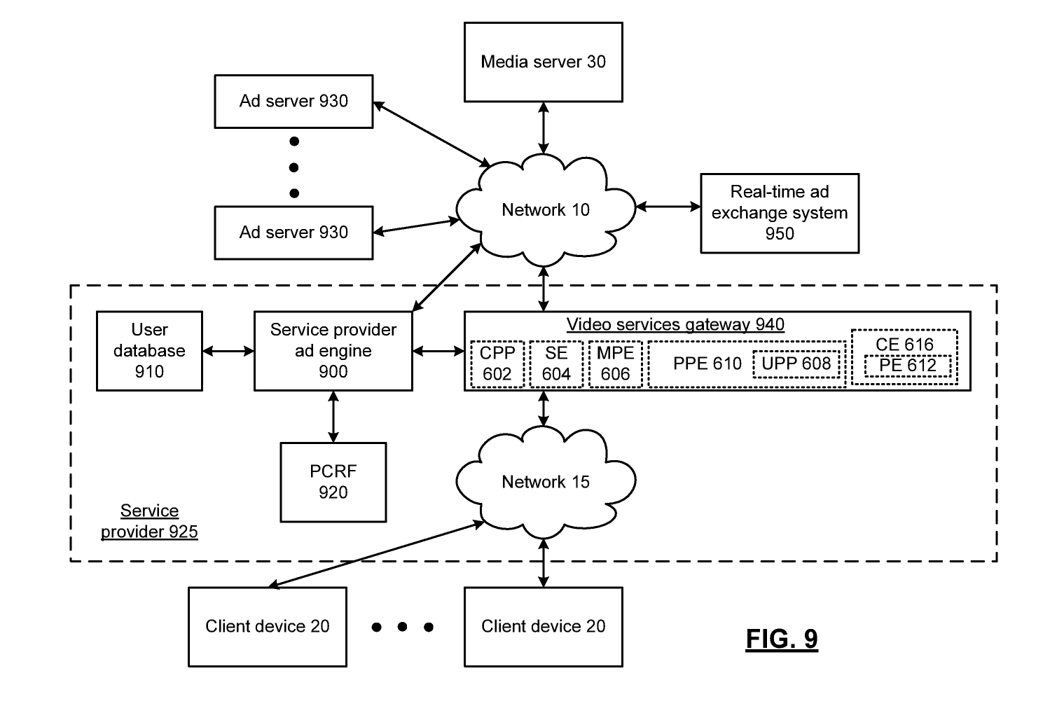

FIG. 9 is a schematic block diagram of a system including a service provider in accordance with an embodiment of the present invention. In particular, an interactive advertising system is presented that includes similar elements described in conjunction with FIGS. 1-8 that are referred to by common reference numerals. In addition, the system includes a plurality of ad servers (AS) 930 that compete in a real-time ad exchange system (REAS) 950 to provide advertisements to client devices 20 via networks 10 and 15.

In many current systems the advertising value chain consists of the content provider and the advertisers and third party aggregators. In these traditional systems, the service provider (fixed or mobile broadband) is not involved in the value chain and hence cannot benefit or offer value in the current ecosystem. The service provider role is to simply carry the advertisements from the content provider to the consumer. If the service provider wishes to enter the ecosystem currently, it has limited options available. The simple option is for the service provider to take on the role of the content provider/aggregator and deliver content to the consumer which can have embedded advertising opportunities. This can limit the service provider to either ad content of its own or ad content that it can obtain from others. The challenges in competing with an over the top content provider can be substantial. Effectively, the service provider's content site has to compete for consumer eyeballs against the large over the top players. This is a difficult challenge as the over the top provider is not limited geographically, they have a global marketplace and hence have larger number of consumers driving ad revenue which usually allows them to acquire better content, which in turn secures more consumers etc.

Service providers may have a lot of inherently valuable subscriber data that can be leveraged in an advertising transaction. However, the service provider may be limited by regulations or privacy agreements to sell this data to third party data aggregation companies that could use this data for advertising purposes. The service provider may have limited options to leverage this information beyond utilizing the data itself to create value.

In the system of FIG. 9, a service provider 925 is presented that leverages its own data to enhance the targeting currently performed at a high demographic level for advertising, increasing the value of the cost per impression. The goal is to extract the value out of the existing subscriber information that the service provider maintains while providing a viable route to participate in the value chain. The IAB and its members currently control around 96% of all online ad revenue in the US market. Instead of competing directly with this system, the service provider 925 operates in conjunction with this evolving infrastructure.

As shown, service provider 925, such as the service provider of network 15, provides a video services gateway (VSG) 940 such as the media session control system 100 described in conjunction with FIGS. 1-8, a network deep packet inspection device or other gateway. In addition the service provider 925 includes a service provider ad engine (SPAE) 900, a user database (UDB) 910, and a policy and charging rules function (PCRF) 920. In an embodiment, the service provider ad engine 900 bids to compete with the ad servers 930 in the real-time ad exchange system. Once a bid is won, the SPAE 900 enhances the value of the advertising opportunity by annotating the ad opportunity with the service provider's 925 subscriber information. The enhanced ad opportunity is submitted again for rebidding and awarded to the other ad servers 930. An increased value of the second bid, or some portion thereof or other compensation, is provided to the service provider 925 in exchange for enhancing the value of the ad.

In an embodiment, the VSG 940 may detect and/or manage video ad opportunities within generic network traffic. The VSG 940 can be configured to route any generic network data traffic for client devices, such as user equipment, to and from a network, and the Internet. The VSG 940 can identify media sessions in generic network data traffic, and permit selective media session-based policy execution and traffic management of in-progress communication sessions (“flows”). Such functionality is a significant enhancement over conventional per-flow or per-subscriber application of policies, in which policies are applied to individual flows (on a per-packet or per-flow basis) or applied to all data for a particular subscriber (per-subscriber).

Based on the service provider's policy rules, the VSG 940 can be configured to determine an enforce media session-based policies to manage user's media traffic to a time-based quota, optionally using quality levels or quality-related parameters. Determinations and enforcement can be performed by working in a closed-loop mode, using continuous real-time feedback to optimize or tune individual media sessions. In conjunction with detailed media session analysis and reporting, the VSG 940 can provide control and transparency to service providers attempting to manage rapidly growing media traffic on their network.

The VSG 940 can perform a number of functions conventionally implemented via separate interconnected physical appliances. Implementation in an integrated architecture, which supports a wide range of processor options, is beneficial to reduce cost while improving performance and reliability. Accordingly, the VSG 940 can have one or more switch elements (SE) 604, one or more media processing elements (MPE) 606, one or more packet processing elements (PPE) 610, one or more control elements (CE) 616, or one or more control plane processors (CPP) 602, optionally in an integrated platform. In some embodiments, the function of one or more of switch elements 604, media processing elements 606, packet processing elements 610, control elements 616, or control plane processors 602 can be integrated, such that a subset of the elements implements the entire functionality of VSG 940 as described herein. In some embodiments, one or more of the elements can be implemented as a server “blade”, which can be coupled together via a backplane. Each of the elements can include one or more processors and memories.

Switch elements 604 can be configured to perform control or user plane traffic load balancing across packet processing elements. Switch elements 604 can also be configured to operate the VSG in one or more of a number of intersection modes. The intersection modes can permit passive monitoring of traffic (supporting measuring and reporting media traffic against a time-based quota, but optionally not enforcing) or permit active management of traffic (supporting measuring, reporting and enforcing).

Media processing elements 606 can be configured to perform inline, real-time, audio and video transcoding of selected media sessions, including pre-roll, midroll/interstitial, and post-roll video advertisements. Media processing elements 606 can generally perform bit rate reduction. In some cases, the media processing element 606 can perform sampling rate reduction (e.g., spatial resolution or frame rate reduction for video, reducing sample frequency or number of channels for audio). In some other cases, it can be beneficial for media processing element 606 to perform format conversion for improved compression efficiency, whereby the output media stream being encoded can be converted to different more efficient format than that of the input media stream being decoded (e.g. H.264/AVC vs MPEG-4 part 2).

The control element 616 can generally perform system management and (optionally centralized) application functions. System management functions can include configuration and command line interfacing, Simple Network Monitoring Protocol (SNMP) alarms and traps and middleware services to support software upgrades, file system management, and system management functions.

The control element 616 can include a policy engine (PE) 612, acting as a Local Policy Decision Point (LPDP). The policies available at the VSG 940 can be dynamically changed by a network operator. In some cases, the policy engine 612 of the control element 616 can access policies located elsewhere on a network. For example, the policy engine 612 can be implemented as part of the 3GPP PCC ecosystem.

The policy engine 612 can maintain and evaluate a set of locally configured node-level policies, including media session policies, and other configuration settings, that are evaluated by a rules engine in order to perform active management of subscribers, locations, and media sessions. Media sessions can be subject to global constraints and affected by dynamic policies triggered during session lifetime. Accordingly, policy engine 612 can keep track of live media session metrics and network traffic measurements. Policy engine 612 can use this information to make policy decisions both when each media session starts and throughout the lifetime of the media session, as the policy engine 612 can adjust polices in the middle of a media session due to changes, e.g. in network conditions, changes in business objectives, time-of-day, etc.

The policy engine 612 can utilize device data relating to the identified client device, which can be used to determine device capabilities (e.g., screen resolution, codec support, etc.). The device database can include a database such as Wireless Universal Resource File (WURFL) or User Agent Profile (UAProf).

The policy engine 612 can also access and use subscriber information. In some cases, subscriber information can be based on subscriber database data obtained from one or more external subscriber databases. Subscriber database data can include quotas and policies specific to a user or a subscription tier. The subscriber database can be accessed via protocols, such as Diameter, Lightweight Directory Access Protocol (LDAP), web services or other proprietary protocols. Subscriber database data can be enhanced with subscriber information available to the system, such as a usage pattern associated with the subscriber, types of multimedia contents requested by the subscriber in the past, the current multimedia content requested by the subscriber, or time of the day the request is made and location of the subscriber making the current request, among other data.

Media session policies include access control, re-multiplexing, request-response modification, client-aware buffer-shaping, transcoding, adaptive streaming control, in addition to the more conventional per-flow actions such as marking, policing/shaping, etc. Media session policy actions can be further scoped or constrained by one or more individual or aggregate media session characteristics, such as: subscriber (IMEI, IMS!, MSISDN, IP address), subscriber tier, roaming status; transport protocol, application protocol, streaming protocol; container type, container meta-data (clip size, clip duration); video attributes (codec, profile, resolution, frame rate, bit rate); audio attributes (codec, channels, sampling rate, bit rate); device type, device model, device operating system, player capabilities; network location, APN, location capacity (sessions, media bandwidth, delivered bandwidth, congested status); traffic originating from a particular media site or service, genre (sports, advertising); time of day; or QoE metric; or a combination thereof.

Packet processing element 610 can be generally configured to analyze user plane traffic across all layers of the TCP/IP (or UDP/IP, or other equivalent) networking stack and identify media sessions via a user plane processor 608. The packet processing element 610 can be configured to immediately re-enqueue packets that do not utilize advanced processing “back to the wire” with very low latency. Packets that are to utilize additional processing can be forwarded internally for deeper processing.

Deeper processing can include parsing of the transport, application and container layers of received/sent user plane packets, and execution of policy based on subscriber, device, location or media session analysis and processing, for example. Packet processing element 610 can include processing on application layer content such as HTTP, RTSP, RTMP, and the like. Packet processing element 610 can include processing on container layer content such as MP4, FLV, HLS, and the like. The packet processing element 610 can forward general data traffic information and specifically media session information, e.g. bit rates, TCP throughput, RTT, etc., to other elements.

Analysis may include generating statistics and QoE measurements for media sessions, including video advertisements, providing estimates of bandwidth required to serve a client request and media stream at a given QoE. Packet processing element can make these values available as necessary within the system. Examples of statistics that can be generated include, e.g., bandwidth, site, device, video codec, resolution, bit rate, frame rate, clip duration, streamed duration, audio codec, channels, bit rate, sampling rate, and the like. QoE measurements computed can include, e.g., delivery QoE, presentation QoE, and combined QoE.

In some cases, the control plane processor 602 can be configured to process control plane messages to extract subscriber identity or mobile device identity information, and to map the mobile devices (e.g., physical or geographic location). The control plane processor 602 can forward the identity and location information to other elements.

For example, in mobile networks using 3GPP GRPS/UMTS, LTE, or similar standards, subscriber and mobile device identity information, location, as well as other mobility parameters can be gathered for subscriber, device, and location-based traffic management and reporting purposes. Such gathering can be accomplished in part by inspecting control plane messages exchanged between gateways, for example GTP-C (GPRS Tunneling Protocol Control) over the Gn interface, GTPv2 over the S4/S11 or S5/S8 interfaces, and the like, or by receiving mobility information from other network nodes, such as the RNC, Mobile Management Entity (MME) and the like.

A media session can generally be considered to have been identified once sufficient traffic relating to that media session has been observed at the application layer. In most cases, the application layer protocols used for media streaming can generally be identified by analyzing the first few bytes of payload data. The amount of input that can be buffered in duration or size can be a limiting factor on how soon a decision is made and whether or not certain policies can be applied. A session identification timer can be used to enforce an upper bound on latency for session identification. After identifying the application payload, the payload can be parsed to find the media content, if any. For example, such identification can be accomplished by dividing the communication into independent interactions, which can correspond to individual request/response pairs. Each interaction is evaluated to determine if the content is streaming media. If the interaction contains streaming media, it is further analyzed to extract media characteristics. Those interactions sharing common media characteristics can be encapsulated into streams. A media session can include a collection of one or more streams. Generally, a video advertisement should be considered its own media session, distinct from the media content being accessed, so it can be monitored and managed independently.

In one example of operation, the video services gateway 940 monitors media session data corresponding to a plurality of media sessions between the media server 30 and the client devices 20 that use the network 15 of service provider 925. The VSG 940 detects an ad request sent via network 15 from a particular client device 20 to the real-time ad exchange system 950 via analysis of the media session data. In particular, the VSG 940 determines when a player of a client device 20 is requesting ad content for an open slot in the media content, and generates an indication of the ad request that is sent to the service provider advertising engine 900. The SPAE 900 receives the indication of the ad request from the video services gateway. The SPAE 900 can then identify the ad auction as it is placed dynamically into the real-time ad exchange system 950. The SPAE 900 then can act in a similar fashion to ad server 930 to generate a bid to the real-time ad exchange system 950 to fulfill the ad opportunity corresponding to the ad request from the client device 20.

The SPAE 900 retrieves subscriber data associated with the client device 20 from a subscriber database such as user database 910 that stores the subscriber's profile. This data can be analyzed by the SPAE 900 and compared to the ad opportunity to determine if, or how much, the ad opportunity can be enhanced. For example, the SPAE 900 can determine how much additional data can be added to the ad opportunity and the potential value of this opportunity. For example, the SPAE 900 can include a predictive model that looks at the difference between the expected value of the bid without enhancements and the expected value of the bid after being enhanced to determine the expected value of the bid enhancement that could be performed by the SPAE 900. This analysis can be used by SPAE 900 in determining on whether to bid on the ad opportunity and further how much to bid on the ad opportunity. When the value opportunity appears positive, the SPAE 900 can bid on the ad opportunity. In another mode of operation, the SPAE 900 can bid amounts that assume that the ad opportunity can be enhanced. For example, if the ad opportunity contains little or no information pertaining to the user, the bids would be commensurately low, and a slightly higher bid generated automatically by the SPAE 900 could win and be used as, itself, an indication that the ad opportunity could be enhanced by the SPAE by including subscriber profile information from the service provider 925.

If the bid is successful, the SPAE 900 annotates the ad opportunity with the subscriber data. In particular, the service provider advertising engine 900 can query the user database 910 for subscriber data relating to preferences, demographic profiles, home location, past user activity and other subscriber profile data and/or other data than could be used in enhancing the value proposition for the ad opportunity. In an embodiment, the SPAE 900 anonymizes the subscriber data associated with user/subscriber of the client device 20 prior to annotating the ad opportunity with the subscriber data in order to protect the privacy of the user/subscriber.

The SPAE 900 then submits the annotated ad opportunity to the real-time ad exchange system 950 for rebidding. In particular, the ad opportunity is then posted back into the ad exchange for ad servers 930 to bid on. When an advertiser has successfully won the ad opportunity, an asset universal resource location (URL) is provided to the ad server 930 in order to return to the video player of client device 20. In this case the URL is provided back to the content provider/aggregator for delivery back to the video player of client device 20. This can be an open market bidding process. In the first instance the service provider 925 is bidding in an open market for the right to provide the ad opportunity and then enhancing the value and re-selling opportunity in a rebidding process to another advertiser for a higher amount.

While the RAES 950 is shown as a single entity, the functionality of RAES 950 can be distributed among multiple different devices that are coupled via a network such as network 10, a private network or other network. In addition, while the ad servers 930 are shown as single devices, the functionality of each ad server 930 can also, or in the alternative, be distributed among multiple different devices that are coupled via a network such as network 10, a private network or other network.

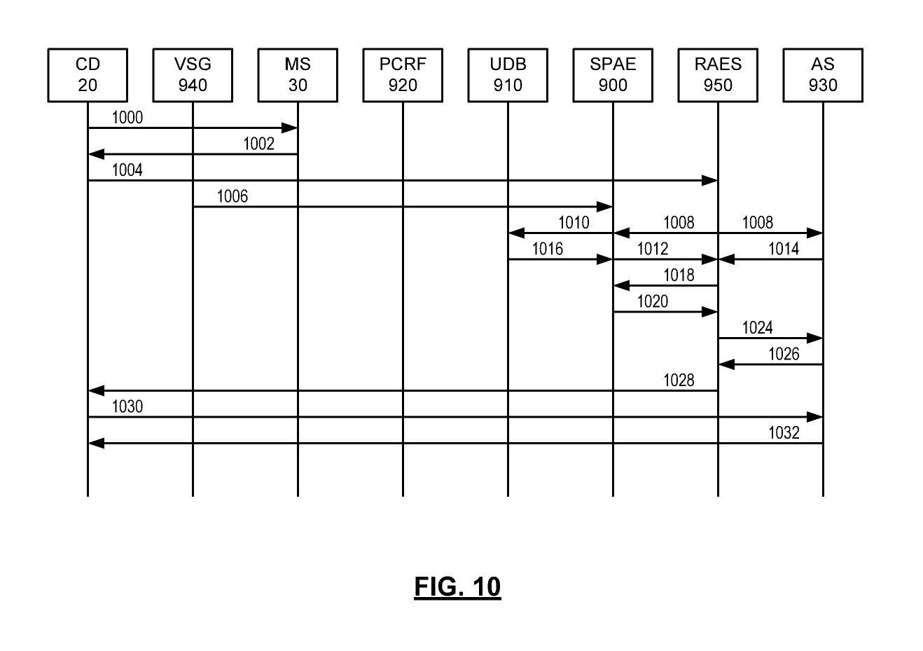

Further details regarding the interactive advertising system including several optional functions and features are presented in conjunction with FIGS. 10-14 that follow.

FIG. 10 is a diagram illustrating communications in accordance with an embodiment of the present invention. In particular a communication diagram is presented that indicates example communications between devices of the system of FIG. 9 that are referred to by common reference numerals. In the examples shown, time is represented from top to bottom. It should be noted however that events could occur in different orderings and with different delays as long as the principles of causality are maintained—i.e. a device cannot respond directly to an event or communication until after that event or communication has occurred.

In 1000, a client device 20 requests media content from media server 30. The media server 30 responds with data such as a link, tag or other data that tells the client device 20 where to obtain advertising content associated with the media request, as shown in 1002. The client device 20 sends an ad request to the real-time ad exchange system 950 as shown in 1004. The VSG 940 detects the ad request or tag in the communication 1004 via analysis of the media session data from the client device 20. In particular, the VSG 940 determines when a player of a client device 20 is requesting ad content for an open slot in the media content, and generates an indication of the ad request 1006 that is sent to the service provider advertising engine 900. The service provider advertising engine 900 receives the indication of the ad request 1006 from the video services gateway 940. The SPAE 900 can then identify the ad auction as it is placed dynamically into the real-time ad exchange system 950. The SPAE 900 then can act in a similar fashion to ad server 930 to generate a bid to the real-time ad exchange system to fulfill the ad opportunity corresponding to the ad request 1004 from the client device 20.

The RAES 950 puts an ad opportunity 1008 out bid to the ad server 930 and the SPAE 900. While a single ad server 930 is shown, multiple ad servers 930 can be involved in the bidding process.

In communications 1010 and 1016 the SPAE 900 requests and receives subscriber data associated with the client device 20 from user database 910. This data can be analyzed by the SPAE 900 and compared to the ad opportunity to determine if, or how much, the ad opportunity can be enhanced. When the value opportunity appears positive, the SPAE 900 can place a bid 1012 on the ad opportunity. Ad server 930 can also place a bid 1014. If the SPAE receives an indication 1018 that the bid 1012 was successful, SPAE 900 annotates the ad opportunity with the subscriber data and generates an enhanced ad opportunity 1020 sent to the RAES 950 for a second bid (a rebid).

In the embodiment shown, the SPAE receives the indication 1018 directly from the RAES 950. The RAES 950, acting either by default knowledge of the nature of SPAE 900, by indication in bid 1012 that a rebidding will follow, by additional communication in response to the indication 1018 or other communication, can operate to hold the ad opportunity for rebid 1020.

In another embodiment, the RAES can communicate the winning bid to the client device 20 for placement with a link to the winning bidder (in this case the SPAE 900). In this case, the VSG 940 can act as a proxy to actively intercept the communication from the RAES to the client device 20 and redirect this to the SPAE 900 as an indication that SPAE 900 has won the bid.

When the SPAE 900 then submits the annotated ad opportunity 1020 to the real-time ad exchange system 950 for rebidding, the new ad opportunity is then posted 1024 back into the ad exchange for ad servers 930 to place bids 1026. When the ad server 930 has successfully won the ad opportunity, an asset universal resource location (URL) 1028 provided by the ad server 930 in bid 1026 is returned to the client device 20 by RAES 950 in order to return to the video player of client device 20. The client device requests the ad content in 1030 from the ad server and receives the ad content in 1032.

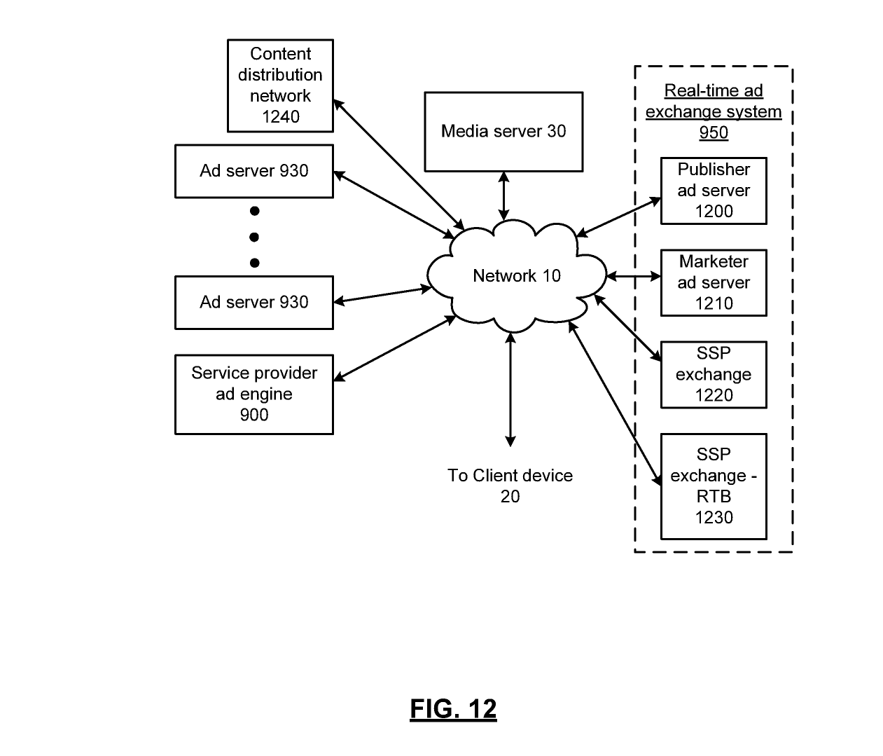

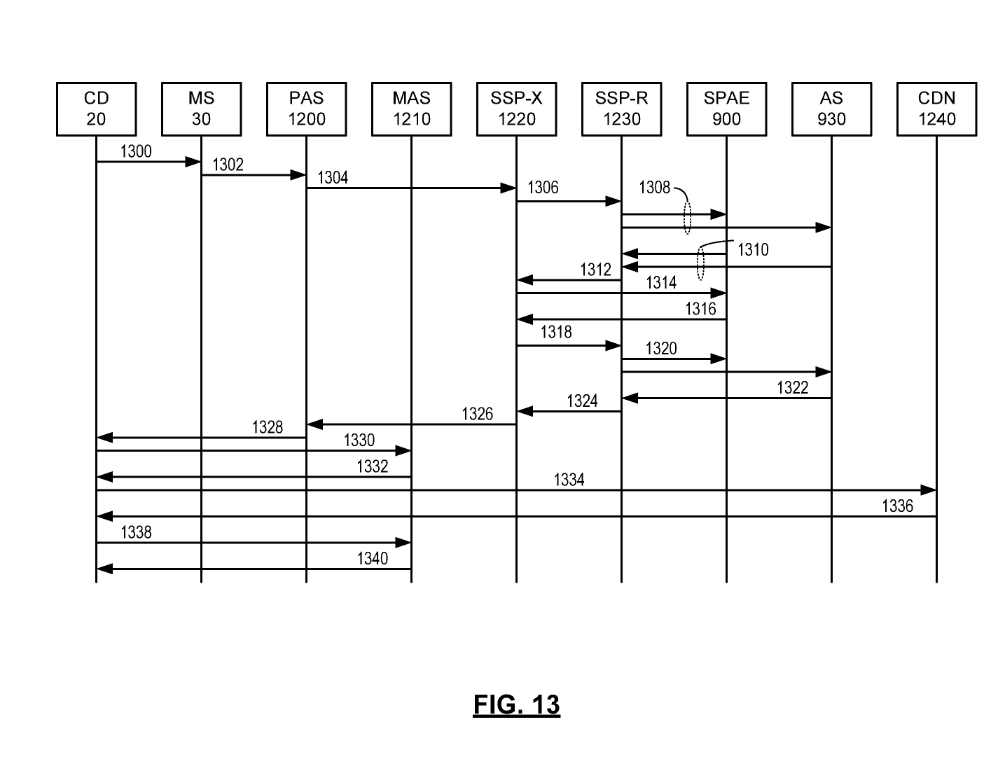

As discussed in conjunction with FIG. 9, while the RAES 950 is shown as a single entity, the functionality of RAES 950 can be distributed among multiple different devices that are coupled via a network such as network 10, a private network or other network. In addition, while the ad servers 930 are shown as single devices, the functionality of each ad server 930 can also, or in the alternative, be distributed among multiple different devices that are coupled via a network such as network 10, a private network or other network. In particular a content distribution network can be employed in conjunction with one or more ad servers to deliver advertising content to the client devices 20. Further details regarding the distributed nature of RAES 950 and an ad server 930 including several optional functions and features and various additional embodiments are described in conjunction with FIGS. 12 and 13 that follows.

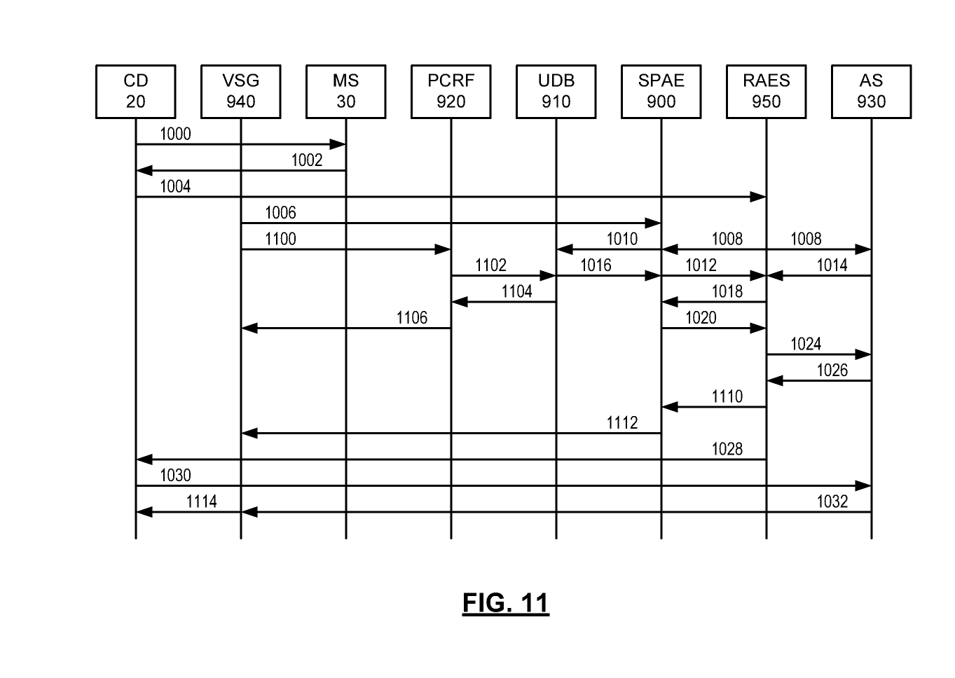

FIG. 11 is a diagram illustrating communications in accordance with an embodiment of the present invention. In particular a communication diagram is presented that indicates example communications between devices of the system of FIG. 9 that are referred to by common reference numerals. Likewise, similar communications presented in conjunction with FIG. 10 are referred to by common reference numerals. In the examples shown time is represented from top to bottom. It should be noted however that events could occur in different orderings and with different delays as long as the principles of causality are maintained—i.e. a device cannot respond directly to an event or communication until after that event or communication has occurred.

In this embodiment, the service provider 925 can further enhance an ad opportunity by providing monitoring and reporting on the quality of ads that are delivered. In particular, the video services gateway 940 can be employed to monitor the delivery of an ad inserted in fulfillment of the annotated ad opportunity or other ad and generates quality data associated with the delivery of the ad.

In traditional systems, tracking within the player of client device 20 pings trackback URLs at the start, 25%, 50%, 75% and full playout of an advertisement. There are also trackback URLs for events such as pausing and skipping in the player. The advertiser only knows how far along the advertisement was played. The advertiser does not know whether the video ad content was received in acceptable quality. In an embodiment, the VSG 940 measures the QoE of all media sessions in the network including advertising sessions. The VSG 940 can measure the quality that the video ad was delivered in and report back to the advertisers the quality that was experienced by the consumer. Currently, advertisers assume that delivery was excellent, however this is not always the case. By providing video quality metrics, the service provider 925 is adding an enhanced layer of transparency with the advertisers such that they understand and know when and if there were problems and can be fairly compensated. This can provide insight into how many ads were delivered with acceptable quality and allows for advertisers to compare between different networks. This innovation may provide visibility and enhanced value that other ad networks could not provide and the advertiser will be more inclined to work with the service provider 925 in a collaborative way as they get better reporting and tracking capabilities.

In a further embodiment, the service provider 925 can further enhance an ad opportunity by not only providing monitoring and reporting on the quality of ads that are delivered but also by proactively controlling the quality of ads that are delivered. For example, the service provider may offer a delivery service level agreement (SLA) associated with an ad opportunity. As previously described in conjunction with FIGS. 1-8, the video services gateway 940 can include a transcoder for transcoding video content delivered to the plurality of client devices. In particular, the video services gateway 940 can be used to control delivery of an ad inserted in fulfillment of the annotated ad opportunity or other advertisements by adaptively transcoding the ad. For example, the video services gateway 940 can be used to retrieve subscriber data corresponding to the client devices for which an ad is to be delivered and can control delivery of an ad inserted in fulfillment of the ad in accordance with the subscriber data. In this fashion, and via other methodologies previously described in conjunction with FIGS. 1-8, the VSG 940 can actively manage the delivery of the video ad content to ensure that it is given the best opportunity to be delivered at all times. If prioritization of the video ad content is allowed in the target market then the VSG can mark the ad content, such as via differential services code point (DSCP) mark or provide another indicator such that the ad receives preferential treatment from a QoS perspective from the network 15. The VSG 940 may decide to disable unnecessary transcoding for the ad content ensuring that the ad gets delivered in the quality that the advertiser intended, bypassing existing transcoding rules that may otherwise reduce the rate or resolution of the delivery or otherwise reduce the QoE associated with the ad.

The VSG 940 may also respond to network congestion events and react in a favorable way to reduce the rate or resolution of the delivery to boost overall QoE. In this case when network resources are at a premium and the ad content has been delivered in too high a quality the VSG 940 can transcode the ad to ensure that playback does not stall and reduce the QoE. The congestion and transcode event can then be reported back from the service provider 925 to the advertiser for potentially a small service credit. It is possible to use the VSG 940 to offer a 2 tier advertising opportunity, to deliver an ad in HD or SD or dynamically select the ad based on network resources and compensate the advertiser depending on what was delivered. This level of sophistication is enhancing value to the advertiser and ultimately will make the ad opportunities offered via service provider 925 more valuable from the advertiser's perspective.

The example shown in FIG. 11 includes several communications that were described in conjunction with FIG. 10 and that are referred to by common reference numerals. In addition, the VSG 940 also responds to the detection of an ad request 1004 by client device 20 by querying the PCRF 920 and/or user database 910 via requests 1100 and 1102 and responses 1104 and 1106 to obtain information on the client device such as device resolution, subscriber tier information and other subscriber/device information that can be used to control the delivery of an ad to the client device 20. After an enhanced ad has been awarded to an ad server 930, the RAES 950 informs the SPAE in 1110 which, in turn informs the VSG 940. In the alternative, the VSG can detect the ad redirect in communication 1028. In the embodiment of monitoring only, the VSG 940 can monitor the quality of delivery of the ad 1114 in response to ad delivery 1032. As previously discussed, the VSG 940 can also act to control the quality of delivery 1114 in response to the ad delivery 1032.

While the forgoing discussion has focused on monitoring and/or control of the delivery of enhanced ads generated as a result of a rebidding process initiated by SPAE 900, as discussed in conjunction with FIG. 9, the VSG 940 can perform similar functionality with respect to other ads detected by VSG 940. In this fashion, ads that are served as part of a traditional ad exchange process can likewise be detected, monitored and controlled by VSG 940 to enhance the value proposition for the service provider 925.

FIG. 12 is a schematic block diagram of a system including a service provider in accordance with an embodiment of the present invention. In particular a communication diagram is presented that indicates devices of the system of FIG. 9 that are referred to by common reference numerals.

As discussed in conjunction with FIGS. 9 and 10, while the RAES 950 was shown as a single entity, the functionality of RAES 950 can be distributed among multiple different devices that are coupled via a network such as network 10, a private network or other network. In the embodiment shown, real-time ad exchange system 950 includes a publisher ad server 1200, a marketer ad server 1210, a supply side platform (SSP) exchange 1220 and a separate SSP exchange to support real-time bidding (RTB) 1230. While the various devices of RAES 950 are shown functionally under a common block, the various subblocks can be provided by different entities, depending on the implementation.

In addition, while the ad servers 930 have been previously shown as single devices, the functionality of each ad server 930 can also, or in the alternative, be distributed among multiple different devices that are coupled via a network such as network 10, a private network or other network. In particular, a content distribution network 1240 can be employed in conjunction by one or more ad servers to provide delivery of the advertising content to the client devices 20 in a network cloud configuration.

The interaction between these distributed devices, including several optional functions and features, is described in conjunction with FIG. 13 that follows.

FIG. 13 is a diagram illustrating communications in accordance with an embodiment of the present invention. In particular a communication diagram is presented that indicates example communications between devices of the system of FIG. 12 that are referred to by common reference numerals. In the examples shown, time is represented from top to bottom. It should be noted however that events could occur in different orderings and with different delays as long as the principles of causality are maintained—i.e. a device cannot respond directly to an event or communication until after that event or communication has occurred.

In contrast to the communications described in conjunction with FIGS. 10 and 11 which included internal communications between the components of service provider 925, the example shown focuses on the communications between the SPAE 900 and ad servers 930, the components of the RAES 950 and the content delivery network 1240. In the parlance of real-time bidding, the SPAE 900 and the ad servers 930 behaves like a Demand Side Platform (DSP). The SPAE acts separately to bid available the slot against other DSPs. As previously described, if the SPAE 900 wins the bid, it re-submits the same slot to the SSP-exchange 1220 still with the use's cookie or original identification but also enhanced with augmented information generated from its own user database 910. The SPAE 900 does not bid on its own enhanced ad during the rebidding. Instead, the SPAE 900 is trying to re-sell the slot with augmented information, for a higher bid.

In this example, a client device sends a request for content 1300 to media server 30 that redirects the request 1302 to a publisher ad server 1200. The publisher ad server 1200 communicates the ad request 1304 to the SSP exchange 1220 optionally with information such as publisher's ID, the site ID of media server 30, a subscriber identification such as a cookie file or other identifier of the client device. The SSP exchange 1220 generates an ad opportunity 1306 that the SSP-RTB 1230 sends out for bids 1308 to ad servers 930 and SPAE 900. The SPAE 900 and ad servers 930 respond with bids 1310. The identification of the winning bidder 1312, including such information as a redirect address, is provided back to the SSP exchange 1220.

In the example shown, the SPAE 900 receives information of the winning bid 1314 and generates an enhanced bid 1316 with its own augmented information. The process repeats with the enhanced ad opportunity being presented 1318 to the SSP-RTB 1230 that sends it out for bids 1320 and receives a winning bid 1322 from ad server 930 that is identified 1324 to SSP exchange 1220. The SSP exchange 1220 returns the wining ad redirect 1326 to the publisher ad server 1200 that passes it in 1328 to the client device 20. The client device 20 uses the ad redirect to generate a call 1330 to the marketer ad server 1210 that returns with a redirect 1332 to the content distribution network 1240 associated with the winning ad server 930. The client device 20 issues a request 1334 for the ad content from the content delivery network 1240 that delivers the ad content in 1336. An exchange 1338 and 1340 between the client device 20 and the marketer ad server 1210 indicate ad delivery.

It should be noted that the various communications described herein are merely illustrative of limited examples of the many ways that an ad exchange service can be effectuated, that a service provider 925 can generate enhanced ads through a rebidding process and otherwise that a service provider 925 can provide value-added services to the ad delivery process.

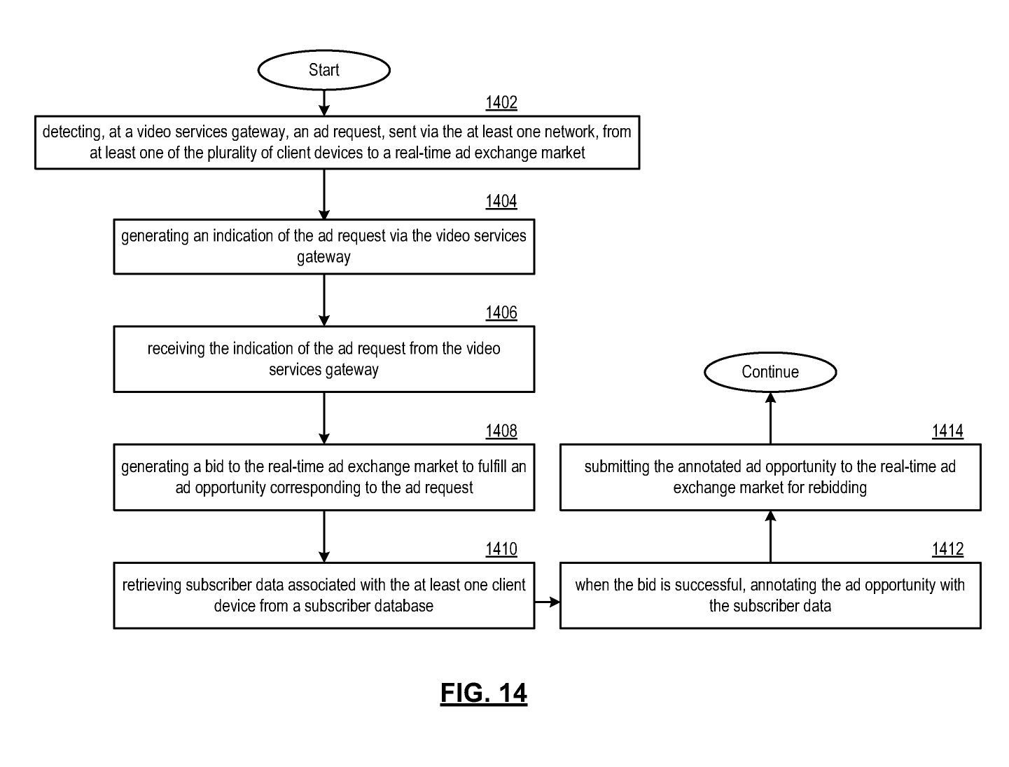

FIG. 14 is a diagram illustrating a method in accordance with an embodiment of the present invention. In particular, a method is presented for use with one or more functions and features described in conjunction with FIGS. 1-13. Step 1402 includes detecting, at a video services gateway, an ad request, sent via the at least one network, from at least one of the plurality of client devices to a real-time ad exchange system. Step 1404 includes generating an indication of the ad request via the video services gateway. Step 1406 includes receiving the indication of the ad request from the video services gateway. Step 1408 includes generating a bid to the real-time ad exchange system to fulfill an ad opportunity corresponding to the ad request. Step 1410 includes retrieving subscriber data associated with the at least one client device from a subscriber database. Step 1412 includes, when the bid is successful, annotating the ad opportunity with the subscriber data. Step 1414 includes submitting the annotated ad opportunity to the real-time ad exchange system for rebidding.

In an embodiment, step 1402 includes monitoring media session data corresponding to the plurality of media sessions, and detecting the ad request via an analysis of the media session data. The at least one network can include a wireless service provider network for providing wireless service to the plurality of client devices.

In an embodiment, the method can further include anonymizing the subscriber data associated with the at least one client device, prior to annotating the ad opportunity with the subscriber data. The method can further includes monitoring, via the video services gateway, delivery of an ad inserted in fulfillment of the annotated ad opportunity, and generating quality data associated with the delivery of the ad inserted in fulfillment of the annotated ad opportunity.

In an embodiment, the method can further include controlling, via the video services gateway, delivery of an ad inserted in fulfillment of the annotated ad opportunity and generates quality data associated with the delivery of the ad inserted in fulfillment of the annotated ad opportunity. Controlling delivery of the ad inserted in fulfillment of the annotated ad opportunity can include adaptively transcoding delivery of the ad inserted in fulfillment of the annotated ad opportunity.

In an embodiment, the method can further include retrieving, via the video services gateway, subscriber data corresponding to the at least one of the plurality of client devices, Further, delivery of the ad inserted in fulfillment of the annotated ad can be controlled via the video services gateway in accordance with the subscriber data.

It is noted that terminologies as may be used herein such as bit stream, stream, signal sequence, etc. (or their equivalents) have been used interchangeably to describe digital information whose content corresponds to any of a number of desired types (e.g., data, video, speech, audio, etc. any of which may generally be referred to as ‘data’).

As may be used herein, the terms “substantially” and “approximately” provides an industry-accepted tolerance for its corresponding term and/or relativity between items. Such an industry-accepted tolerance ranges from less than one percent to fifty percent and corresponds to, but is not limited to, component values, integrated circuit process variations, temperature variations, rise and fall times, and/or thermal noise. Such relativity between items ranges from a difference of a few percent to magnitude differences. As may also be used herein, the term(s) “configured to”, “operably coupled to”, “coupled td”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”. As may even further be used herein, the term “configured to”, “operable to”, “coupled to”, or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item.

As may be used herein, the term “compares favorably”, indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1. As may be used herein, the term “compares unfavorably”, indicates that a comparison between two or more items, signals, etc., fails to provide the desired relationship.

As may also be used herein, the terms “processing module”, “processing circuit”, “processor”, and/or “processing unit” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, and/or processing unit may be, or further include, memory and/or an integrated memory element, which may be a single memory device, a plurality of memory devices, and/or embedded circuitry of another processing module, module, processing circuit, and/or processing unit. Such a memory device may be a read-only memory, random access memory, volatile memory, non-volatile memory, static memory, dynamic memory, flash memory, cache memory, and/or any device that stores digital information. Note that if the processing module, module, processing circuit, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, and/or processing unit executes, hard coded and/or operational instructions corresponding to at least some of the steps and/or functions illustrated in one or more of the Figures. Such a memory device or memory element can be included in an article of manufacture.

One or more embodiments have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality.

To the extent used, the flow diagram block boundaries and sequence could have been defined otherwise and still perform the certain significant functionality. Such alternate definitions of both functional building blocks and flow diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors executing appropriate software and the like or any combination thereof.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

The one or more embodiments are used herein to illustrate one or more aspects, one or more features, one or more concepts, and/or one or more examples. A physical embodiment of an apparatus, an article of manufacture, a machine, and/or of a process may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

Unless specifically stated to the contra, signals to, from, and/or between elements in a figure of any of the figures presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

The term “module” is used in the description of one or more of the embodiments. A module implements one or more functions via a device such as a processor or other processing device or other hardware that may include or operate in association with a memory that stores operational instructions. A module may operate independently and/or in conjunction with software and/or firmware. As also used herein, a module may contain one or more sub-modules, each of which may be one or more modules.

While particular combinations of various functions and features of the one or more embodiments have been expressly described herein, other combinations of these features and functions are likewise possible. The present disclosure is not limited by the particular examples disclosed herein and expressly incorporates these other combinations.

1. A system for delivering streaming media via at least one network in a plurality of media sessions between a media source and a corresponding plurality of client devices, the system comprising:
a video services gateway, coupled to the at least one network, that detects an ad request, sent via the at least one network, from at least one of the plurality of client devices to a real-time ad exchange system and generates an indication of the ad request;
a service provider advertising engine, coupled to the video services gateway, that:
receives the indication of the ad request from the video services gateway;
generates a bid to the real-time ad exchange system to fulfill an ad opportunity corresponding to the ad request;
retrieves subscriber data associated with the at least one of the plurality of client devices from a subscriber database;
when the bid is successful, annotates the ad opportunity with the subscriber data and submits the annotated ad opportunity to the real-time ad exchange system for rebidding.

2. The system of claim 1 wherein the video services gateway monitors media session data corresponding to the plurality of media sessions and detects the ad request via an analysis of the media session data.

3. The system of claim 1 wherein the at least one network includes a wireless service provider network for providing wireless service to the plurality of client devices.

4. The system of claim 1 wherein the service provider advertising engine anonymizes the subscriber data associated with the at least one client device prior to annotating the ad opportunity with the subscriber data.

5. The system of claim 1 wherein the video services gateway monitors delivery of an ad inserted in fulfillment of the annotated ad opportunity and generates quality data associated with the delivery of the ad inserted in fulfillment of the annotated ad opportunity.

6. The system of claim 1 wherein the video services gateway controls delivery of an ad inserted in fulfillment of the annotated ad opportunity and generates quality data associated with the delivery of the ad inserted in fulfillment of the annotated ad opportunity.

7. The system of claim 6 wherein the video services gateway includes a transcoder for transcoding video content delivered to the plurality of client devices and wherein the video services gateway controls delivery of the ad inserted in fulfillment of the annotated ad opportunity by adaptively transcoding the ad.

8. The system of claim 6 wherein the video services gateway retrieves the subscriber data corresponding to the at least one of the plurality of client devices and wherein the video services gateway controls delivery of the ad inserted in fulfillment of the annotated ad opportunity in accordance with the subscriber data.

9. A method for delivering streaming media via at least one network in a plurality of media sessions between a media source and a corresponding plurality of client devices, the method comprising:
detecting, at a video services gateway, an ad request, sent via the at least one network, from at least one of the plurality of client devices to a real-time ad exchange system;
generating an indication of the ad request via the video services gateway;
receiving the indication of the ad request from the video services gateway;
generating a bid to the real-time ad exchange system to fulfill an ad opportunity corresponding to the ad request;
retrieving subscriber data associated with at least one of the plurality of client devices from a subscriber database;
when the bid is successful, annotating the ad opportunity with the subscriber data; and
submitting the annotated ad opportunity to the real-time ad exchange system for rebidding.

10. The method of claim 9 wherein detecting the ad request includes:
monitoring media session data corresponding to the plurality of media sessions; and
detecting the ad request via an analysis of the media session data.

11. The method of claim 9 wherein the at least one network includes a wireless service provider network for providing wireless service to the plurality of client devices.

12. The method of claim 9 further comprising:
anonymizing the subscriber data associated with the at least one of the plurality of client devices prior to annotating the ad opportunity with the subscriber data.

13. The method of claim 9 further comprising:
monitoring, via the video services gateway, delivery of an ad inserted in fulfillment of the annotated ad opportunity; and
generating quality data associated with the delivery of the ad inserted in fulfillment of the annotated ad opportunity.

14. The method of claim 9 further comprising:
controlling, via the video services gateway, delivery of an ad inserted in fulfillment of the annotated ad opportunity and generates quality data associated with the delivery of the ad inserted in fulfillment of the annotated ad opportunity.

15. The method of claim 14 wherein controlling the delivery of the ad inserted in fulfillment of the annotated ad opportunity includes adaptively transcoding the delivery of the ad inserted in fulfillment of the annotated ad opportunity.

16. The method of claim 14 further comprising:
retrieving, via the video services gateway, the subscriber data corresponding to the at least one of the plurality of client devices;
wherein the delivery of the ad inserted in fulfillment of the annotated ad opportunity is controlled via the video services gateway in accordance with the subscriber data.

17. A system for delivering streaming media via at least one network in a plurality of media sessions between a media source and a corresponding plurality of client devices, the system comprising:
a video services gateway, coupled to the at least one network, that monitors media session data corresponding to the plurality of media sessions and detects an ad request, sent via the at least one network, from at least one of the plurality of client devices to a real-time ad exchange system via analysis of the media session data and generates an indication of the ad request;
a service provider advertising engine, coupled to the video services gateway, that:
receives the indication of the ad request from the video services gateway;
generates a bid to the real-time ad exchange system to fulfill an ad opportunity corresponding to the ad request;
retrieves subscriber data associated with the at least one of the plurality of client devices from a subscriber database;
when the bid is successful, annotates the ad opportunity with the subscriber data and submits the annotated ad opportunity to the real-time ad exchange system for rebidding.

18. The system of claim 17 wherein the video services gateway monitors delivery of an ad inserted in fulfillment of the annotated ad opportunity and generates quality data associated with the delivery of the ad inserted in fulfillment of the annotated ad opportunity.

19. The system of claim 17 wherein the video services gateway includes a transcoder for transcoding video content delivered to the plurality of client devices and wherein the video services gateway controls delivery of an ad inserted in fulfillment of the annotated ad opportunity by adaptively transcoding the ad.

20. The system of claim 17 wherein the video services gateway retrieves the subscriber data corresponding to the at least one of the plurality of client devices and wherein the video services gateway controls delivery of an ad inserted in fulfillment of the annotated ad opportunity in accordance with the subscriber data.
